(19) United States
(12) Patent Application Publication
(10) Pub. No.: US 2005/0170297 A1
(43) Pub. Date: Aug. 4, 2005

(54) Silver halide emulsion and silver halide photographic material by use thereof

(75) Inventors: Rieko Ren, Tokyo (JP); Toshiya Kondo, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Photo Imaging, Inc.

(21) Appl. No.: 11/007,547

(22) Filed: Dec. 8, 2004

(30) Foreign Application Priority Data
Dec. 18, 2003 (JP) JP2003-420517

(51) Int. Cl. G03C 1/494

(52) U.S. Cl. 430/502

(57) ABSTRACT

A silver halide emulsion is disclosed, comprising a dispersing medium and silver halide grains, wherein at least 35% by number of the silver halide grains is accounted for by tabular grains (a) having [111] major faces, (b) having an aspect ratio of not less than K and not more than (K+2) wherein K is a numerical value to the first decimal place and selected to be within the range of from 8.0 to 40.0, and (c) having side-faces with a proportion of a [100] side-face per grain of not less than L % and not more than (L+10)% wherein L is a numerical value to the first decimal place and selected to be within the range of from 5.0 to 80.0.

### FIELD OF THE INVENTION

The present invention relates to a noble silver halide photographic emulsion and a silver halide photographic material by use thereof.

### BACKGROUND OF THE INVENTION

Silver halide photographic materials (hereinafter, also denoted simply as photographic materials) are said to be a matured product reaching an extremely high degree of perfection, while required performance covers many factors, such as enhanced sensitivity, superior image quality and minimized variation in performance due to storage conditions and required qualities have recently become still higher. Specifically with respect to enhanced sensitivity and enhanced image quality, further enhanced performance is desired to maintain predominance of silver halide photographic material along with technical advancement of digital cameras.

To achieve further enhancement in sensitivity and image quality in silver halide emulsion (hereinafter, also denoted simply as emulsion), on the other hand, there have been continuously made technical studies to enhance the ratio of sensitivity to grain size per silver halide grain.

As is generally known in the art, silver halide grains contained in a silver halide emulsion have various forms, including regular crystal silver halide grains such as cubic, octahedral or tetradecahedral grains, tabular silver halide grains having a single twin-plane or plural parallel twin-planes, and tetrapod-like or rod-like silver halide grains having non-parallel twin planes. Of these, tabular silver halide grains (hereinafter, also denoted simply as tabular grains) are considered to have the following photographic characteristic advantages:
1. relatively high ratio of surface area to grain volume (also called specific surface area) allows a large amount of sensitizing dye to be adsorbed onto the grain surface, resulting in enhanced spectral sensitivity relative to inherent sensitivity;
2. coating and drying a silver halide emulsion containing tabular grains result in the tabular grains to be arranged parallel to the surface of a support, leading to reduced thickness of the coated layer and enhanced sharpness of the photographic material;
3. light-scattering due to silver halide grains is reduced, resulting in images exhibiting enhanced resolution;
4. reduced sensitivity to blue light (inherent sensitivity) can reduce the density of a yellow filter for a green-sensitive layer or a red-sensitive layer, or can remove the yellow filter; and
5. when the same sensitivity as for conventional grains is achieved, such a characteristic grain form can reduce the coating weight of silver, resulting in enhanced ratio of sensitivity/graininess and superior resistance to natural radiation rays.

With regard to the prior art relating to tabular grains, preparation methods and techniques for using them are disclosed in U.S. Pat. Nos. 4,434,226, 4,439,520, 4,414,310, 4,433,048, 4,414,306, and 4,459,353; JP-B Nos. 4-36374, 5-16015 and 6-44132 (hereinafter, the term JP-B refers to Japanese Patent Publication); and JP-A Nos. 6-43605, 6-43606, 6-214331, 6-222488, 6-230493 and 6-258745 (hereinafter, the term JP-A refers to unexamined Japanese Patent Application Publication).

The use of tabular grains exhibiting a relatively high aspect ratio is valid to efficiently draw forth the foregoing advantages of tabular grains. However, as is known in the art, a higher aspect ratio renders it difficult to maintain uniformity of the grain form so that tabular grains prepared by the prior art result in deteriorated uniformity among grains of various grain characteristics such as grain size, grain shape, iodide content, area ratio of a specific face index and the like, leading to deteriorated graininess and decreased gradation.

To overcome the foregoing problems, tabular grains exhibiting a high aspect ratio and improved distribution of grain size (equivalent circle diameter) or grain thickness were disclosed, for example, in JP-B No. 5-60574 and JP-A Nos. 2001-142170, 2001-159799 and 2001-255613. However, only such improvements in grain size distribution of equivalent circle diameter and grain thickness distribution were insufficient in terms of uniformity of the grain shape. It was proved that even if both the distribution of grain size (corresponding to equivalent circle diameter) and the distribution of grain thickness are numerically improved, fluctuation in grain shape resulted in non-uniformity in quantum sensitivity of the individual silver halide grains.

### SUMMARY OF THE INVENTION

Accordingly, it is an object of the present invention to provide a silver halide emulsion of enhanced sensitivity and high contrast, exhibiting superior graininess, and a silver halide photographic material by use the same.

In one aspect the present invention is directed to a silver halide emulsion comprising a dispersing medium and silver halide grains, wherein at least 35% by number of the total silver halide grains is accounted for by silver halide grains meeting the following requirements of (a) to (c):
(a) tabular silver halide grains having [111] major faces,
(b) having an aspect ratio falling within the range of not less than K and not more than (K+2) wherein K is a numerical value to the first decimal place and selected to be within the range of from 8.0 to 40.0, and
(c) having side-faces with a proportion of a (100) side-face per grain of not less than L % and not more than (L+10)% of total side-faces of the grain wherein L is a numerical value to the first decimal place and selected to be within the range of from 5.0 to 80.0.

### DETAILED DESCRIPTION OF THE INVENTION

In a novel aspect of this invention, the silver halide emulsion is comprised of a dispersing medium and silver halide grains, in which at least 35% of the total number of the silver halide grains are accounted for by tabular silver halide grains having [111] major faces, an aspect ratio of not less than K and not more than (K+2) (in which K is a numerical value calculated to the first decimal place and selected from the range of 8.0 to 40.0) and having a [100] side-faces with a proportion of not less than L % and not more than (L+10)% of the total side-face of the grain (in which L is a numerical value calculated to the first decimal place and selected from the range of 5.0 to 80.0). This means to reduce the coefficient of variation based on an aspect ratio and the coefficient of variation in proportion of [100] side face of the side-faces of the tabular grains. In this invention, the foregoing K and L are defined as follows:
K=(average aspect ratio)−1
L (%)=(average proportion of [100] side-face)−5%

The tabular grains having [111] major faces account for at least 35% of the total number of silver halide grains, preferably 80% to 100%, more preferably 90% to 100%, and still more preferably 97% to 100%.

The aspect ratio of silver halide grains is defined as follows and can be obtained by determination of an equivalent circle diameter and grain thickness of the individual grains:
aspect ratio=(equivalent circle diameter)/(grain thickness)

The average equivalent circle diameter is an arithmetic average of equivalent circle diameters of the grains, to the third significant figure, with the final figure rounded off and at least 1,000 grains randomly selected are measured. The equivalent circle diameter is the diameter of a circle having an area equivalent to the projected area of the major face of a tabular grain. The equivalent circle diameter can be determined by measuring the grain diameter or projection area employing 10,000 to 70,000 factor electron micrographs of silver halide grains.

To determine the grain diameter or aspect ratio of silver halide grains, the projected area or thickness for each grain can be determined in accordance with the following procedure. A sample is prepared by coating a tabular grain emulsion containing a latex ball of a known diameter as an internal standard on a support so that the major faces are arranged in parallel to the support surface. After being subjected to shadowing by carbon vapor evaporation, a replica sample is prepared in any of the conventional replica methods. From electron micrographs of the sample, the diameter of a circle equivalent to the grain projected area and grain thickness are determined using an image processing apparatus. In this case, the grain projected area can be determined from the internal standard and the projection area and the grain thickness can be determined from the internal standard and silver halide grain shadow.

The tabular grains relating to this invention preferably have an aspect ratio of at least 8, more preferably at least 10, still more preferably at least 15, and optimally at least 20. The numerical value, K is preferably from 8.0 to 40.0, more preferably from 10.0 to 35.0, and still more preferably from 15.0 to 25.0. The tabular grains having an aspect ratio of not less than K and not more than (K+2) preferably account for at least 45% by number of the total silver halide grains, and more preferably at least 60%.

The tabular grains preferably have an equivalent circle diameter of from 0.6 to 4.0 μm, more preferably from 1.0 to 3.5 μm, and still more preferably from 1.2 to 3.0 μm. The tabular grains preferably have a thickness of not more than 0.25 μm, more preferably not more than 0.20 μm, and still more preferably from 0.02 to 0.16 μm.

The tabular grains preferably exhibit a coefficient of variation based on aspect ratio of not more than 40%, more preferably not more than 30%, and still more preferably from 1% to 10%. The coefficient of variation of equivalent circle diameter preferably is not more than 30%, more preferably not more than 20%, and still more preferably not more than 10%. The coefficient of variation of grain thickness preferably is not more than 40%, more preferably not more than 30%, still more preferably not more than 20%, and optimally not more than 10%.

The coefficient of variation is defined as follows:
coefficient of variation (%)=[(standard deviation)/(average value)]×100

Thus, a coefficient of variation in aspect ratio of tabular grains, that of equivalent circle diameter and that of thickness are each defined as below:
coefficient of variation in aspect ratio (%)=[(standard deviation of aspect ratio)/(average aspect ratio)]×100
coefficient of variation in equivalent circle diameter (%)=[(standard deviation of equivalent circle diameter)/(average equivalent circle diameter)]×100
coefficient of variation in thickness (%)=[(standard deviation of thickness)/(average thickness)]×100

In one preferred embodiment of this invention, tabular silver halide grains of this invention meet the following requirement:
Y≦X
where X is a coefficient of variation in equivalent circle diameter of the tabular grains, represented by the following equation (1) and Y is a coefficient of variation in equivalent circle diameter of the tabular grains, represented by the following equation (2):
X (%)=0.6A+6.0 (1)
Y (%)=[(standard deviation of equivalent circle diameter)/(average equivalent circle diameter)]×100 (2),
where A is an average aspect ratio of the tabular grains.

At least 70% by number of the tabular grains of this invention are preferably accounted for by hexagonal tabular grains. The hexagonal tabular grain refers to a tabular grain exhibiting a ratio of adjacent linear edge lengths of 0.1 to 10 (preferably 0.2 to 5) in a replica sample of a coat sample obtained by coating silver halide grains so that their major faces are arranged parallel to the substrate.

It is preferred that the silver halide emulsion of this invention contains rod-like grains at 0.5% by number or less. Similarly to silver halide grains having no or a single twin plane or two or more non-parallel twin planes, the rod-like grains are not only responsible for causing fogging in the chemical sensitization stage but also often causes clogging in a filter which are used for removing alien particles during the emulsion coating stage, so that it is preferred to reduce such rod-like grains to an extremely low level.

To achieve homogeneity in reactivity among grains during chemical sensitization or spectral sensitization, the coefficient of variation in grain size of the entire silver halide grains is preferably not more than 25%.

The tabular grains are crystallographically classified as twinned crystal grains. Twinned crystal grains refer to crystal grains having at least one twinned plane within the grain. Classification of silver halide twinned crystal grains is described in Klein & Moisar's report (Photographishe Korrespondenz, vol. 99, page 99, and vol. 100, page 57). The tabular grains relating to this invention are those having at least two twin planes. The tabular silver halide grains preferably have at least two parallel twin planes within the grain. The twin planes exist substantially parallel to the face having the largest area of faces forming the surface of the tabular grain, which is a [100] face and called the major face(s). In one preferred embodiment of this invention, two twin planes exist parallel to the major faces.

Silver halide grains having no or only a single twin plane or two or more non-parallel twin planes are in a regular hexahedral or regular octahedral form, in a triangular cone or rod form or in an irregular form. These grains which are not tabular grains having a relatively high aspect ratio, not only result in little improvement in photographic characteristics but also often causes fogging during chemical sensitization, and it is therefore preferred to reduce such grains as much as possible. Silver halide grains having no or only a single twin plane, or two or more non-parallel twin planes exist preferably at less than 10% by number, and more preferably less than 3%.

The average of the spacing between twin planes parallel to the major faces is preferably not less than 1 nm and not more than 30 nm, more preferably not less than 1 nm and not more than 20 nm, and still not less than 1 nm and not more than 12 nm. The coefficient of variation of the spacing between twin planes among grains is preferably not more than 40%, and more preferably not more than 30%.

A twin plane can be observed using a transmission electron-microscope in the following manner. Thus, a photographic emulsion is coated on a support to prepare a sample so that the major face of tabular grains contained are arranged parallel to the support surface. The thus prepared sample is cut using a diamond cutter to obtain ca. 0.1 μm thick slices. The presence of twin plane(s) can be confirmed through observation of this slice using a transmission electron microscope. In this invention, the spacing between two twin planes of the tabular grains is determined in such a manner that in the foregoing transmission electron microscopic observation of the slice, at least 100 tabular grains exhibiting a section vertical to the major faces are selected, then, the spacing between at least two twin planes is determined for each grain and the thus obtained spacing are averaged of the total grains to determine the spacing between twin planes as defined in the invention.

The spacing between at least two twin planes can be controlled by the optimum selection or combination of factors influencing super-saturation at the nucleation stage, such as gelatin concentration, temperature, iodide ion concentration, pBr, ion supplying rate, stirring speed, and gelatin species. In general, nucleation at a highly super-saturated state shortens the twin plane spacing. These super-saturation factors are detailed, for example, in JP-A Nos. 63-92942 and 1-213637.

The coefficient of variation in proportion of [100] side-face in the side-faces of the tabular grains can be determined similarly to “coefficient of variation in proportion of [100] face in projection area” described in JP-A No. 2000-241922, but it is necessary to work out so that vapor deposition onto the side-face and SEM observation become feasible at the time of coating on a conductive substrate and drying. For example, a silver halide emulsion having removed a binder is diluted with distilled water and dispersed onto the conductive surface and slowly dried, whereby most grains are oriented vertically or obliquely by surface tension of distilled water. Alternatively, a dry sample is cut in with a knife so as to stand silver halide grains. The thus prepared deposition sample is observed with a scanning electron-microscope (SEM) and only side-faces are chosen to determine the occupation ratio of [100] face in the side-faces of the individual tabular grains. For example, a hexagonal tabular grain contains six side-faces, each of which is separately measured.

In the tabular grain of this invention, the coefficient of variation in occupation ratio of [100] faces in a side-face is preferably not more than 40%, more preferably not more than 30%, still more preferably not more than 20%, and optimally from 0.1% to 10%. In this invention, the numerical value, L is from 5.0 to 80.0, preferably from 10.0 to 40.0, and more preferably from 20.0 to 30.0. Grains of not less than L and not more than (L+10) preferably account for at least 45% by number of the total grains, and more preferably at least 60%.

The average iodide content of silver halide grains contained in the silver halide emulsion preferably is from 0.1 to 40 mol %, more preferably from 0.3 to 30 mol %, and still more preferably from 0.5 to 20 mol %. To satisfy the main photographic characteristics such as speed or developability, an iodide content of 2 to 8 mol % is specifically preferred. The iodide content of silver halide grains can be determined using the EPMA method (Electron Probe Micro Analyzer method). Thus, silver halide grains are dispersed so as to be not in contact with each other when preparing a sample. The sample is irradiated with an electron beam, while cooled at a temperature of not more than −100° C. using liquid nitrogen, and characteristic X-ray intensities of silver and iodine, radiated from single silver halide grains are measured to determine iodide content of the grains. According to the foregoing procedure, iodide contents determined for respective grains are measured for at least 100 grains and the averaged value thereof is defined as the average iodide content of the grains.

The silver halide grains relating to this invention preferably include plural silver halide phases differing in iodide content in the interior of the grain. Core/shell type silver halide grains are also preferred, having external silver halide phase having a higher or lower iodide content than the internal phase. Any number of the plural internal silver halide phases differing in iodide content may be feasible and the silver halide grains preferably comprise at least 3 phases, more preferably at least 4 phases, and still more preferably at least 5 phases.

In this invention, the average iodide content of the outermost surface within a major face of silver halide grains described in JP-A No. 11-153841 is preferably not less than 8 mol %, more preferably not less than 10 mol %, and still more preferably not less than 12 mol %. The average iodide content of the outermost surface of the side-face is preferably not more than 8 mol %, more preferably not more than 5 mol %, and still more preferably not more than 3 mol %. The iodide content of the outermost surface of silver halide grains refers to an iodide content inclusive of the surface to a depth of 5 nm from the grain surface.

The surface iodide content of silver halide grains can be determined by the XPS method (X-ray Photoelectron Spectroscopy) in the following manner. Thus, a sample is cooled to a temperature of −110° C. or less in an ultra high vacuum of 1.33×10⁻⁶ Pa or less, then, exposed to X-rays for probe of MgKα at an X-ray source voltage of 15 kV and an X-ray source current of 40 mA, and measured with respect to Ag3d5/2, Br3d, and I3d3/2 electrons. The integral peak intensity is corrected by a sensitivity factor and halide composition on the outer surface layer is determined from the thus obtained intensity ratio. The XPS method as a method for determining the iodide content on the silver halide grain surface is described in JP-A 2-24188. When measured at room temperature, however, the outer surface iodide content could not be precisely determined due to destruction of the sample accompanied with X-ray exposure. However, the inventors of this application succeeded in precisely determining the outermost surface iodide content by cooling the sample to such a temperature so that destruction of the sample was not caused. Thereby, it was proved that in grains differing in halide composition between the surface and the interior, such as core/shell grains and in grains having a high iodide layer or a low iodide layer localized on the outermost surface, the value measured at room temperature differs greatly from net composition, due to decomposition of silver halide and diffusion of halides (specifically, iodide) caused by exposure to X-rays.

Specifically, the XPS method used in this invention is carried out according to the following procedure. Thus, a 0.05 wt. % aqueous proteinase solution is added to a silver halide emulsion sample and stirred at 45° C. for 30 min. to degrade the gelatin. The emulsion is subjected to centrifugal separation to allow emulsion grains to sediment, followed by removal of the supernatant liquid. Then, distilled water is added thereto to disperse emulsion grains in water and allow a thin coating on a mirror-polished silicon wafer to prepare a test sample. Surface iodide measurement by the XPS method was conducted using the thus prepared sample. To prevent destruction of the sample caused by X-ray exposure, the sample was cooled to a temperature of 110 to −120° C. in a closed chamber for XPS measurement. The sample was exposed to X-rays for probe of MgKα at an X-ray source voltage of 15 kV and an X-ray source current of 40 mA, and measured with respect to Ag3d5/2, Br3d, and I3d3/2 electrons. The integral peak intensity was corrected for by a sensitivity factor and halide composition on the outer surface layer was determined from the thus obtained intensity ratio.

The average iodide content of the outermost surface of the major face can be similarly determined, provided that coating is made so that the major faces of tabular grains are arranged parallel to the silicon wafer and the foregoing XPS method is applied. Emulsion grains are coated on the silicon wafer so that the grains are not aggregated or overlapped. There may be used a coating aid to prevent aggregation of the grains. The thus prepared measurement sample is preferably confirmed using an optical microscope or SEM.

The process of the preparation of the silver halide emulsion of this invention include a low temperature nucleation step, a temperature rising step, a high temperature ripening step and a growth step. In the initial low temperature nucleation step, an aqueous silver salt solution and an aqueous halide salt solution are added into an aqueous dispersing-medium solution contained in a reaction vessel to form fine silver halide grains having twin plane(s). Subsequent to the low temperature nucleation step, the thus formed fine grains are heated to the objective ripening temperature, while controlling a temperature, a silver ion or halide ion concentration and a pH. During the temperature rising step, the fine grains are allowed to selectively grow in the twin plane direction through Ostwald ripening to make the grain thickness uniform as possible. In the subsequent high temperature ripening step, ripening is carried out with controlling a silver ion or halide ion concentration, a pH and a silver halide solvent concentration. During the ripening step, smaller grains or unnecessary grains (such as regular crystal grains or unwanted twinned crystal grains) are dissolved as possible and grains having parallel twin planes are selectively allowed to grow to make the equivalent circle diameter uniform to form tabular grains. The stage including the foregoing low temperature nucleation step, temperature rising step and low temperature ripening step may be called a nucleation step. To make the grain size or shape uniform, it is essential to optimize conditions of the nucleation step. In the growth step subsequent to the nucleation step, necessary amounts of a silver salt solution and halide salt solution are added, while controlling the addition rate, temperature, silver ion or halide ion concentration and pH, whereby tabular grains of a larger size are obtained.

The silver halide emulsions used in the invention contain a dispersion medium. The dispersion medium is a compound capable of acting as a protective colloid for silver halide grains. It is preferred to allow the dispersion medium to be present from the start of the nucleation stage to completion of grain growth stage. Preferred examples of the dispersion medium include gelatin and hydrophilic colloids. There is preferably used gelatin such as alkali or acid processed gelatin having a molecular weight of the level of 100,000 or enzyme-treated gelatin described in Bull. Soc. Sci. Photo. Japan No. 16, pp. 30 (1966). Examples of the hydrophilic colloid include gelatin derivatives, graft polymers of gelatin and other polymers, proteins such as albumin and casein, cellulose derivatives such as hydroxyethyl cellulose, carboxymethyl cellulose, cellulose sulfuric acid ester, saccharide derivatives such as sodium alginate and starch derivatives and synthetic hydrophilic polymer material including homopolymers such as polyvinyl alcohol, polyvinyl alcohol partial acetal, poly(N-vinyl pyrrolidine), polyacrylic acid, polymethacrylic acid, polyacrylamide, polyvinyl imidazole, and polyvinyl pyrazolo, and their copolymers.

In the preparation of the silver halide emulsion of this invention, the foregoing low temperature nucleation step and/or temperature rising step and/or high temperature ripening step are carried out preferably using, as a dispersing medium, a gelatin having a methionine content of 20 mmol per g of gelatin or less, or a gelatin having an average molecular weight of 40,000 or less and a methionine content of 20 mmol per gram of gelatin. The methionine content is more preferably not more than 10 μmol/g of gelatin, still more preferably not more than 5 μmol/g, and optimally from 0 to 3 mmol/g.

Oxidation of alkali-processed gelatin by using oxidizing agents is useful to achieve a methionine content of less than 30 μmol/g. Oxidizing agents to oxidize gelatin include, for example, hydrogen peroxide, ozone, peroxy-acid, halogen, thiosulfonic acid compounds, quinines, and organic peracids. Of these, hydrogen peroxide is preferred. Determination of the methionine content is described in many literatures. Amino acid analysis, HPLC method, gas chromatography and silver ion titrimetry are employed with reference to, for example, Journal of Photographic Science, vol. 28, page 111; ibid, vol. 40, page 149; ibid, vol. 41, page 172; ibid, vol. 42, page 117; and Journal of Imaging Science and Technology, vol. 39, page 367.

In the preparation of the silver halide emulsion of this invention, the low temperature nucleation step is carried out preferably in an aqueous gelatin solution having a methionine content of 20 μmol/g or less, maintained at a temperature of 40° C. or lower in a reaction vessel, a gelatin concentration of 0.2% to 2% and a pBr of 1.6 to 2.6. The nucleation step is carried out preferably at 30° C. or lower, and more preferably 25° C. or lower. The gelatin concentration during the nucleation is preferably from 0.5% to 1.5%. The pBr of the gelatin solution is preferably 1.8 to 2.4.

In the temperature rising step, the emulsion temperature within the reaction vessel is changed preferably by at least 20° C., more preferably at least 40° C., and still more preferably at least 50° C. The temperature rising speed is preferably at least 0.7° C./min, more preferably 1.0° C./min, still more preferably at least 1.5° C./min, and optimally at least 2.0° C./min. In the high temperature ripening step, the gelatin concentration of the emulsion is preferably 0.5% to 2.5%, and more preferably 0.8% to 2%; and the pBr is preferably 1.2 to 2.6, and more preferably 1.4 to 2.4. In the high temperature ripening step, ammonia ripening is preferably used in combination, in which the ammonium concentration of the emulsion in the reaction vessel is preferably 1×10⁻⁴ to 2×10⁻¹ mol/l, and more preferably 1×10⁻³ to 1×10⁻¹ mol/l.

Chemically modified gelatin may also preferably used in the growth step or washing step of silver halide grains. In that case, at least 10% by weight (preferably at least 30%, and more preferably at least 50%) of the dispersing medium contained in the prepared silver halide emulsion preferably is a chemically modified gelatin. Chemically modified gelatins include, for example, gelatin, an amino group of which is substituted, as described in JP-A Nos. 5-72658, 9-197595 and 9-251193.

Polyalkyleneoxide compounds are preferably used in the foregoing low temperature nucleation step and/or temperature rising step and/or high temperature ripening step. Preferred example of polyalkyleneoxide compounds include those described in U.S. Pat. No. 5,252,453.

The tabular silver halide grains preferably contain dislocation lines and the form of the dislocation lines can optimally be selected. For example, there are selected dislocation lines that are linearly exist in a specific crystallographic direction, or curved dislocation lines. There are also selected dislocation lines existing overall within the grain or dislocation lines existing in a specific site of the grain, for example, in the form of dislocation lines localizing in the fringe portions (circumferential portion) of the grain, those localizing in the major faces or those localizing in the vicinity of corners of the grain. In the tabular grains, the dislocation lines exist preferably in the fringe portion and more preferably in the fringe portion and the major faces. The tabular grains preferably contain at least 10 dislocation lines and more preferably at least 20 dislocation lines in the fringe portion of the grain.

The dislocation lines in silver halide grains can be directly observed by means of transmission electron microscopy at a low temperature, for example, in accordance with methods described in J. F. Hamilton, Phot. Sci. Eng. 11 (1967) 57 and T. Shiozawa, Journal of the Society of Photographic Science and Technology of Japan, 35 (1972) 213. Silver halide tabular grains are taken out from an emulsion while making sure not to exert any pressure that causes dislocation in the grains, and they are then placed on a mesh for electron microscopy. The sample is then observed by transmission electron microscopy, while being cooled to prevent the grain from being damaged by the electron beam. Since electron beam penetration is hampered as the grain thickness increases, sharper observations are obtained when using an electron microscope of higher voltage (e.g., at a voltage 200 kV or more for a 0.25 μm thick grain). From the thus-obtained electron micrograph, the position and number of the dislocation lines in each grain can be determined. Any of several methods for introducing the dislocation lines into the silver halide grain may be used.

In this invention, at least 50% (preferably at least 70%) by the projected area of the tabular grains contain at least 10 dislocation lines in the fringe portion of the grain.

In the invention, the expression “having dislocation lines in the fringe portion of the grain” means that the dislocation lines exist in the vicinity of the circumferential portion, in the vicinity of the edge or in the vicinity of the corner of the tabular grain. Concretely, when the tabular grain is observed vertical to the major face of the grain and a length of a line connecting the center of the major face (i.e., a center of gravity of the major face, which is regarded as a two-dimensional figure) and a corner is represented by “L”, the fringe portion refers to the region outside the figure connecting points at a distance of 0.50 L from the center with respect to the respective corners of the grain.

The dislocation lines can be introduced by various methods, in which, at a desired position of introducing the dislocation lines during the course of forming silver halide grains, an aqueous iodide (e.g., potassium iodide) solution is added, along with an aqueous silver salt (e.g., silver nitrate) solution by a double jet technique, only an iodide solution is added, iodide-containing fine grains are added or an iodide ion releasing agent is employed, as disclosed in JP-A No. 6-11781. Of these, the double jet addition of an aqueous iodide solution and an aqueous silver salt solution, addition of iodide-containing fine grains and addition of an iodide ion-releasing agent are preferred.

When introduction of dislocation lines into silver halide grains is conducted by the addition of fine silver iodide grains, the average size of the fine silver iodide grains is preferably not more than 0.08 μm, more preferably not more than 0.05 μm, and still more preferably not more than 0.03 μm. The coefficient of variation of grain size of the fine silver iodide grains is preferably not more than 40%, more preferably not more than 30%, still more preferably not more than 20%, and optimally not more than 10%.

When dislocation lines are introduced into silver halide emulsion grains using an iodide containing fine grain emulsion, preferred reaction conditions are as follows. Thus, the emulsion is added preferably at a temperature of 30 to 80° C. and more preferably 40 to 70° C. The amount of the iodide containing fine grain emulsion preferably is from 1 to 5 mol %, based on the total amount of silver halide after completion of grain growth.

Specifically, the iodide ion releasing agent, which is a compound capable of releasing an iodide ion upon reaction with a base or a nucleophilic reagent is represented by the following formula (1):
R—I formula (1)
where R is a univalent organic group. R is preferably an alkyl group, alkenyl group, alkynyl group, aryl group, aralkyl group, heterocyclic group, acyl group, carbamoyl group, alkyloxycarbonyl group, aryloxycarbonyl group, alkylsulfonyl group, arylsulfonyl group, or sulfamoyl group. R is also preferably an organic group having 30 or less carbon atoms, more preferably 20 or less carbon atoms, and still more preferably 10 or less carbon atoms. R may be substituted by at least one substituent. The substituent may be further substituted. Preferred examples of the substituent include a halogen atom, alkyl group, aryl group, aralkyl group, heterocyclic group, acyl group, acyloxy group, carbamoyl group, alkyloxycarbonyl group, aryloxycarbonyl group, alkylsulfonyl group, arylsulfonyl group, or sulfamoyl group, alkoxy group, aryloxy group, amino group, acylamino group, ureido group, urethane group, sulfonylamino group, sulfinyl group, phosphoric acid amido group, alkylthio group, arylthio group, cyano, sulfo group, hydroxy, and nitro.

The iodide ion releasing agents (R—I) are preferably iodo-alkanes, a iodo-alcohol, iodo-carboxylic acid, iodo-amid, and their derivatives, more preferably iodo-amide, iodo-alcohol and their derivatives, still more preferably iodo-amide substituted by a heterocyclic group, and specifically preferable examples include (iodoacetoamido)benzenesulfonat.

Preferred examples of the iodide ion releasing agent are shown below.

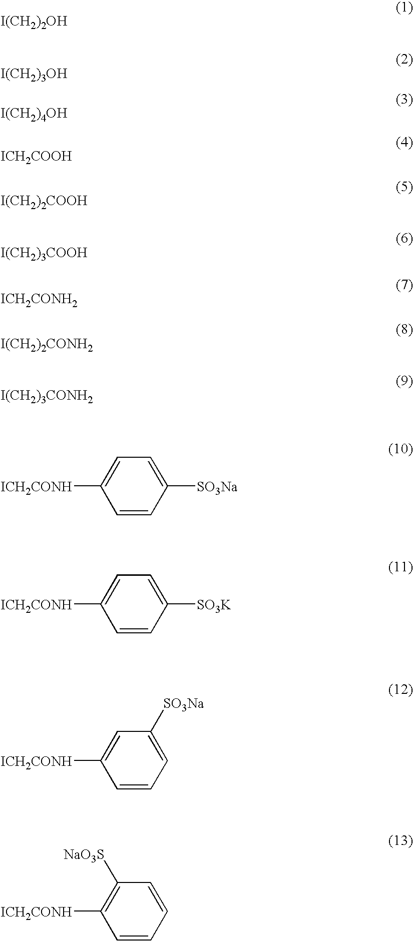

In cases when the iodide ion releasing agent is reacted with a nucleophilic agent (or nucleophile) to release an iodide ion, preferred nucleophilic agents include, for example, preferred nucleophilic agents include hydroxy ion, sulfite ion, thiosulfate ion, sulfonic acid ion, carboxylic acid ion, ammonia, amines, alcohols, ureas, thioureas, phenols, hydrazines, sulfides, and hydroxamic acids. Of these, hydroxy ion, sulfite ion, thiosulfate ion, sulfonic acid ion, carboxylic acid ion, ammonia and amines are more preferred, and hydroxy ion and sulfite ion are specifically preferred.

When dislocation lines are introduced into silver halide emulsion grains using the iodide ion-releasing agent, preferred reaction conditions are as follows. Thus, the reaction temperature is preferably 30 to 80° C., and more preferably 40 to 70° C. The pAg immediately before introduction of dislocation lines is preferably 7.0 to 10.0, and more preferably 7.5 to 9.5. The iodide ion releasing agent is added preferably in an amount of 1 to 5 mol %, based on the total amount of silver halide. The pH at the time of an iodide ion releasing reaction is preferably 7.0 to 11.0, and more preferably 8.0 to 10.0. In cases when a nucleophilic agents other than a hydroxy ion, the amount thereof is preferably 0.25 to 2.0 times, more preferably 0.5 to 1.5, and still more preferably 0.8 to 1.2 times that of the iodide ion releasing agent.

Silver halide emulsions relating to this invention preferably contain polyvalent metals, a polyvalent metal ions, polyvalent metal complexes or polyvalent metal ion complexes in the interior or surface of silver halide grains. The polyvalent metals, a polyvalent metal ions, polyvalent metal complexes or polyvalent metal ion complexes in the interior or surface of silver halide grains include, for example, metal atoms, ions, their complexes and salts thereof, selected from 3 to 7 series (specifically, 4 to 6 series) of the periodic table, such as elements of Fe, Co, Ni, Ru, Rh, Pd, Re, Os, Ir, Pt, Mg, Al, Ca, Sc, Ti, V, Cr, Mn, Cu, Zn, Ga, Ge, As, Se, Sr, Y, Mo, Zr, Nb, Cd, In, Sn, Sb, Ba, La, W, Au, Hg, Tl, Pb, Bi, Ce and U, and compounds containing the foregoing metals. The metal compound to be doped is used preferably in the form of a single salt or a metal complex. The metal complex preferably is a six, five, four or two coordination complex and an octahedral six coordination complex or a planar four coordination complex is more preferred. The metal complex may be a mononuclear or polynuclear complex. Examples of ligands constituting the complex include CN⁻, CO, NO₂⁻, 1,10-phenanthroline, 2,2′-bipirydine, SO₃⁻, ethylenediamine, NH₃, pyridine, H₂O, NCS⁻, NCO⁻, NO₃⁻, SO₄⁻, OH⁻, CO₃²⁻, SSO₃²⁻, N₃⁻, S₂⁻, F⁻, Cl⁻, Br⁻ and I⁻. In the case of NCS⁻, either the N-atom or S-atom can coordinate.

To allow the foregoing polyvalent metals to be contained in silver halide emulsions used in this invention, the following commonly known techniques are applicable: B. H. Carroll, “Iridium Sensitization: A Literature Review”, Photogr. Sci. Eng., vol. 24, No. 6, page 265-267 (1980); U.S. Pat. Nos. 1,951,933, 2,628,167, 3,687,676, 3,761,267, 3,890,154, 3,901,711, 3,901,713, 4,173,483, 4,269,927, 4,413,055, 4,477,561, 4,581,327, 4,643,965, 4,806,462, 4,828,962, 4,835,093, 4,902,611, 4,981,780, 4,997,751, 5,057,402, 5,134,060, 5,153,110, 5,164,292, 5,166,044, 5,204,234, 5,166,045, 5,229,263, 5,252,451, 5,252,530; EPO No. 0244184, 0488737, 0488601, 0368304, 0405938, 0509674, 0563046; WO No. 93/02390. Further, U.S. Pat. Nos. 4,847,191, 4,933,272, 4,981,781, 5,037,732, 937,180, 4,945,035, 5,112,732: EPO No. 0509674, 0513738; WO No. 91/10166, 92/16876; German Patent No. 298,320; and U.S. Pat. Nos. 5,360,712 and 5,024,931.

Further, Research Disclosure (hereinafter, also denoted simply as RD) vol. 367, November 1994, item 36736 comprehensively describes criteria to select dopants forming a shallow electron trap. Of the foregoing polyvalent metal atoms, their ions, and complexes and complex ions, six-coordinate complex ions represented by the following formula are preferred:
[ML₆]
wherein M is a filled frontier orbital polyvalent metal ion and preferably Fe²⁺, Ru²⁺, Os²⁺, Co²⁺, Rh²⁺, Ir²⁺, Pd⁴⁺, or Pt⁴⁺; L₆ represents six coordinated ligands which are independently selected, provided that at least four of the ligands are each an anionic ligand, and at least one of the ligands (preferably at least three, and more preferably at least four of the ligands) is more electronegative than a halide ligand; and n is 1−, 2−, 3− or 4−.

Examples of a dopant or dopant ion capable of providing a shallow electron trap are shown below:
SET-1 [Fe(CN)₆]⁴⁻
SET-2 [Ru(CN)₆]⁴⁻
SET-3 [Os(CN)₆]⁴⁻
SET-4 [Rh(CN)₆]³⁻
SET-5 [Ir(CN)₆]³⁻
SET-6 [Fe(pyrazine)(CN)₅]⁴⁻
SET-7 [RuCl(CN)₅]⁴⁻
SET-8 [OsBr(CN)₅]⁴⁻
SET-9 [RhF(CN)₅]³⁻
SET-10 [IrBr(CN)₅]³⁻
SET-11 [FeCO(CN)₅]³⁻
SET-12 [RuF₂(CN)₄]⁴⁻
SET-13 [OsCl₂(CN)₄]⁴⁻
SET-14 [RhI₂(CN)₄]³⁻
SET-15 [IrBr₂(CN)₄]³⁻
SET-16 [Ru(CN)₅(OCN)]⁴⁻
SET-17 [Ru(CN)₅(N₃)]⁴⁻
SET-18 [Os(CN)₅(SCN)]⁴⁻
SET-19 [Rh(CN)₅(SeCN)]³⁻
SET-20 [Ir(CN)₅(HOH)]²⁻
SET-21 [Fe(CN)₃Cl₃]³⁻
SET-22 [Ru(CO)₂(CN)₄]³⁻
SET-23 [Os(CN)Cl₅]⁴⁻
SET-24 [Co(CN)₆]³⁻
SET-25 [Ir(CN)₄(oxalate)]³⁻
SET-26 [In(NCS)₆]³⁻
SET-27 [Ga(NCS)₆]³⁻

Ir compounds usable in this invention preferably are K₂IrCl₆, K₃IrCl₆ and K₂IrBr₆. Further preferred examples of other polyvalent metal compounds include InCl₃, K₄Fe(CN)₆, K₃Fe(CN)₆, K₄Ru(CN)₆ and Pb(NO₃)₂. In this invention, at least one selected from polyvalent metal atoms and their ions, complexes and complex ions is used and atoms of Ir, Ru, Os, Fe, Rh, Co, In, Ga, Ge, Pd and Pt, their ions and complexes thereof are specifically preferred.

To allow the foregoing polyvalent metal atoms, their ions, complexes and complex ions to be include in the silver halide emulsion, silver halide grains may be doped during grain growth or during grain ripening. Alternatively, grain growth is interrupted and after being doped, the growth may further continue. Alternatively, after completion of grain growth, a dopant may be introduced into the grain surface. Doping can also be conducted by carrying out nucleation, physical ripening or grain formation in the presence of a dopant. The dopant concentration is preferably 1×10 ⁻⁷ to 1×10 ⁻² mol, more preferably 1×10⁻⁶ to 1×10 ⁻³ mol, and still more preferably 2×10⁻⁶ to 1×10⁻⁴ mol per mol of silver halide.

To allow polyvalent metals to be occluded in silver halide grains, such metal compounds may be directly dispersed in a silver halide emulsion or added to the emulsion through solution in solvents such as water, methanol and ethanol. Alternatively, addition of commonly known additives into the emulsion may be applicable. At least one selected from polyvalent metal atom, or its ion, complex or complex ion may be added together with fine silver halide grains, or there may be added fine silver halide grains containing at least one of polyvalent metal atom, or its ion, complex or complex ion. A preparation method using fine silver halide grains containing at least one of polyvalent metal atom, or its ion, complex or complex ion is referred to JP-A No. 11-212201.

Silver halide emulsions relating to this invention preferably are silver bromide, silver iodobromide or silver iodochlorobromide, and more preferably silver iodobromide or silver iodochlorobromide. The chloride content preferably is 0 to 50 mol %, more preferably 0 to 30 mol %, and still more preferably 0 to 10 mol %. The silver halide emulsion is preferably comprised of silver halide grains internally having plural silver halide phases differing in iodide content. In one embodiment of this invention, the silver halide emulsion is preferably comprised of core/shell type tabular grains having plural silver halide phases differing in halide composition. The core/shell type grains preferably comprise at least 3 phases, and more preferably at least 4 phases differing in halide composition. In one preferred embodiment of this invention, the silver halide grains preferably comprise at least 5 phases. In this regard, the difference in halide content between adjacent phases preferably is at least 1 mol %, and more preferably at least 3 mol %. Silver halide emulsions relating to this invention may have any halide composition, and silver iodobromide or silver iodochlorobromide is preferred. In the core/shell type grains, the difference in iodide content preferably is at least 1 mol %, and more preferably at least 3 mol %. The difference in volume between phases of the core/shell type grains preferably is at least 1%, more preferably at least 3%, and still more preferably 5%. The core/shell type grains may be comprised of a high iodide or low iodide internal phase or alternately comprised of a high iodide phase and a low iodide phase. The outermost layer of the core/shell type grains preferably is a low iodide phase containing less than 3 mol % iodide, more preferably less than 1 mol % iodide, and still more preferably no iodide.

Silver halide emulsions used in this invention may be subjected to reduction sensitization. The reduction sensitization can be conducted by adding a reducing agent to a protective colloid solution used for grain growth. Alternatively, the protective colloid solution used for grain growth is ripened or mixed at a low pAg of 7 or less or at a high pH of 7 or more. These procedures may be conducted singly or in combination thereof.

Examples of preferred reducing agents include thiourea dioxide, ascorbic acid and its derivatives, and tin (II) salt. Other reducing agents include, for example, borane compounds, hydrazine compounds, silane compounds, amines and polyamines. The reducing agent is added preferably in an amount of 10⁻⁸ to 10⁻² mol, and more preferably 10⁻⁷ to 10⁻³ mol per mol of silver halide. In cases when the reduction sensitization is carried out by maintaining a protective colloid solution at a pAg less than 7.0, a silver salt is added to the protective colloid solution to adjust the pAg to an appropriate value, followed by ripening or growing silver halide grains. The silver salt preferably is a water soluble silver salt, and more preferably silver nitrate. The pAg is preferably not more than 7.0, and more preferably 2.0 to 5.0 (in which the pAg is a common logarithm of the reciprocal of Ag⁺ concentration). In cases when the reduction sensitization is carried out by maintaining a protective colloid solution at a pH higher than 7.0, an alkaline compound is added to the protective colloid solution to adjust the pH to an appropriate value, followed by ripening or growing silver halide grains. Examples of the alkaline compound include sodium hydroxide, potassium hydroxide and ammonia, and compounds other than ammonia are preferred.

Reducing agents, silver salts or alkaline compounds may be added instantaneously or added over a period of a given time to perform reduction sensitization, in which the addition thereof may be conducted at a constant flow rate or at an accelerated flow rate. The addition may be dividedly carried out. Prior to addition of a water-soluble silver salt and/or water-soluble halide to a reaction vessel, the foregoing compounds may be allowed to exist therein. The compound may be mixed with a halide solution and added together with the halide. The compound may be added separately from the water-soluble silver salt and halide.

There may also be used oxidizing agents for the purpose of deactivating the reducing agent. Examples of such oxidizing agents include (aqueous) hydrogen peroxide and its adduct (e.g., H₂O₂, NaBO₂.H₂O₂.3H₂O, 2Na₂CO₃.3H₂O₂. Na₄P₂O₇.2H₂O₂, 2Na₂SO₄.H₂O₂.2H₂O), peroxyacid salts (e.g., K₂S₂O₈, K₂C₂O₆, K₂P₂O₈), peroxy complex compound {e.g., K₂[Ti(O₂)C₂O₄].3H₂O,}, peracetic acid, ozone, I₂ and thiosulfonates. The oxidizing agents may be used for the purpose other than deactivating the reducing agent. The oxidizing agent may be added in any amount, depending on the kind of the reducing agent, reduction sensitization conditions, addition time and conditions of the oxidizing agent, and preferably in an amount f of 1×10⁻³ to 1×10⁵ mol per mol of reducing agent. The oxidizing agent may be added prior to addition of the reducing agent. The oxidizing agent may be added in a manner similar to conventional additives. For example, the oxidizing agent is added in solution in organic solvents such as alcohols or water.

After addition of the oxidizing agent, a reducing agent is newly added to neutralize the excessive oxidizing agent. Such a reducing agent is a substance capable of reducing the oxidizing agent, and examples thereof include sulfonic acids, di- and tri-hydroxybenzenes, chromans, hydrazins and hydrazides, p-phenylenediamines, aldehydes, aminophenols, ene-diols, oximes, reductones, phenidones, sulfites and ascorbic acid derivatives.

In this invention, there can be used a silver halide emulsion containing silver halide grains having silver halide protrusions on the grain surface. The silver halide emulsion containing silver halide grains having silver halide protrusions on the grain surface refers to a silver halide emulsion in which the silver halide grains having silver halide protrusions on the grain surface account for at least 30%, preferably at least 50%, and more preferably at least 70% of the total grain projected area.

In the silver halide emulsion containing silver halide grains having silver halide protrusions on the grain surface, the silver halide protrusions on the grain surface preferably are epitaxial. It is generally supposed that epitaxially arranging silver halide protrusions at a selected site on a silver halide grain as a substrate (hereinafter, also called host grain) reduces competition of conduction band electrons ejected by absorption of photons upon imagewise exposure to sensitizing sites, thereby enhancing sensitivity. U.S. Pat. No. 4,435,501 discloses epitaxially adhering a silver salt onto a selected site on the surface of a tabular silver halide grain, thereby achieving enhanced sensitivity. This U.S. Patent describes that enhanced sensitivity is attributed to epitaxial adhesion of the silver salt being limited to a small area portion on the surface of the tabular grain. Thus, an epitaxial arrangement limited to a specific portion within the major face of the tabular grain is effective for epitaxial arrangement covering overall the major face, an epitaxial arrangement substantially limited to edge portions of the host grain, thereby limiting coverage on the major face is preferred; and an epitaxial arrangement limited to corners or vicinity thereof, or a separate portion is more effective and preferred. Spacing between corners of the host grain reduces competition of photoelectrons to an extent capable of achieving the maximum sensitivity. U.S. Pat. No. 4,435,501 teaches retarding epitaxial adhesion reduces the number of epitaxially arranged sites.

In this invention, it is preferred to limit the epitaxially arranged silver halide protrusions to a small portion on the surface of the host grain and it is more preferred to limit the protrusions to corners or neighbors thereof. Specifically, less than 50% is preferred and less than 30% is more preferred. The silver amount of the epitaxially arranged silver halide protrusions preferably is 0.3 to 25%, and more preferably 0.5 to 15%. The position and the occupied area of the epitaxial arrangement are preferably even among grains, not to vitiate uniformity in grain characteristics. An uniform arrangement in at least 80% of the edges of the grains is preferred, an uniform arrangement in at least 80% of the corners of the grains is more preferred, and an uniform arrangement in at least 90% of the corners of the grains is still more preferred. The coefficient of variation of an occupied area of the epitaxial arrangement among grains is preferably not more than 40%, more preferably not more than 30%, still more preferably 20% and optimally not more than 10%.

In one specifically preferred embodiment of employing a silver halide emulsion containing silver halide grains having silver halide protrusions on the grain surface, the epitaxially arranged silver halide protrusions are limited to corners or neighbors of the corners in the host grain, and commonly known methods are applicable to achieve this. U.S. Pat. No. 4,435,501 discloses a technique of allowing spectral sensitizing dyes or aminoazaindenes to be adsorbed as a site director, which is preferably applicable to this invention.

To avoid structural breakdown of the host grain, the total solubility of the epitaxially arranged silver halide protrusions preferably is higher that that of the silver halide host grain. Accordingly, the epitaxially arranged silver halide protrusions are preferably silver chloride. Silver chloride forms a face-centered cubic lattice similar to silver bromide, making it easier to be epitaxially adhered.

To maintain structural consistency of the host grain, epitaxial adhesion is preferably performed under conditions of restraining solubility of a halide forming the host grain. However, in one case, halide composition of the epitaxially arranged silver halide protrusions is the same as that of the host grain. Thus, silver chloride protrusions contain a small amount of bromide or iodide.

In the preparation of silver halide emulsion relating to the invention, various methods are applicable to the formation of silver halide grains. Thus, single jet addition, double jet addition, triple jet addition or fine silver halide grain-supplying method is usable singly or in combination. A technique of controlling the pH and pAg in a liquid phase forming silver halide along with the grain growth rate may be applied in combination. The grain formation is preferably carried out under the condition close to critical grain growth rate.

A seed grain emulsion may be used in the preparation of silver halide emulsions relating to the invention. Silver halide grains contained in the seed emulsion may be those having a regular crystal structure, such as cubic, octahedral or tetradecahedral grains or those having an irregular crystal structure such as spherical or tabular grains. These grains may have any proportion of (100) face and (111) face. The seed grains may be composite of these crystal forms or a mixture of various crystal form grains. Specifically, silver halide grains contained in the seed emulsion preferably are twinned crystal grains, and more preferably twinned crystal grains having two parallel twin planes.

In any case of using the seed emulsion or using no seed emulsion, commonly known methods are applicable as conditions for nucleation and ripening of silver halide grains. Silver halide solvents known in the art may be used in the preparation of silver halide emulsions but it is preferred to avoid the use of such silver halide solvents in the formation of tabular substrate grains, except for at ripening after nucleation.

Any of the acidic precipitation process, neutral precipitation process or ammoniacal precipitation process is applicable to the preparation of silver halide emulsions relating to the invention, and the acidic or neutral precipitation process is preferred. Halide and silver ions may be simultaneously mixed or either one of them may be added into the other one. Taking account of critical growth rate of silver halide crystals, halide and silver ions may be sequentially or simultaneously added, while controlling the pAg and pH within the vessel. Halide conversion may be applied at any stage in the silver halide to vary halide composition.

In cases where fine silver halide grains are used in the invention, the fine silver halide grains may be prepared in advance to or concurrently to the preparation of silver halide grains relating to the invention. In the latter concurrent preparation, as described in JP-A 1-183417 and 2-44335, the fine silver halide grains can be prepared using a mixer separately provided outside the reaction vessel for preparing the silver halide grains relating to the invention. It is preferred that a preparation vessel is separately provided from the mixer and fine silver halide grains which have been prepared in the mixer are optimally prepared in the preparation vessel so as to fit the growth environment within the reaction vessel for preparing the silver halide grains relating to the invention, thereafter, the fine silver halide grains are supplied to the reaction vessel. In cases when reduction-sensitized fine grains are not intended, the fine grains are preferably prepared in an acidic or neutral environment (at a pH≦7). In cases when intending the reduction-sensitized fine grains, the fine grains can be prepared by combining means for reduction sensitization. The fine silver halide grains can be prepared by mixing an aqueous silver ion solution and aqueous halide ion solution while optimally controlling super-saturation factors. Control of super-saturation factors can be carried out with reference to the teaching of JP-A 63-92942 and 63-311244.

The fine silver halide grains are preferably prepared at a pAg of not less than 3.0, more preferably not less than 5.0, and still more preferably not less than 8.0 to inhibit production of reduced silver nuclei. The fine silver halide grains are also preferably prepared at a temperature of not higher than 50° C., more preferably not higher than 40° C., and still more preferably not higher than 35° C. Protective colloids used for preparation of the fine silver halide grains are the same as used in the preparation of silver halide grains mentioned earlier.

Forming fine silver halide grains at a relatively low temperature retards an increase in size of the fine grains due to Ostwald ripening after formation of the fine grain. However, gelatin tends to coagulate at a low temperature, so that it is preferred to use a low molecular weight gelatin described in JP-A No. 2-166422, synthetic molecular compounds or natural polymeric compounds other than gelatin. The protective colloid concentration preferably is not less than 1%, more preferably not less than 2%, and still more preferably not less than 3% by weight. The fine grain size preferably is not more than 0.1 μm, and more preferably not more than 0.05 μm. The fine silver halide grains may optionally be reduction-sensitized or be occluded with metal ions.

In the manufacture of silver halide emulsions relating to this invention, a concentration operation is preferably conducted by means of ultrafiltration at the stage of at least a part of the grain growth process. Specifically, preparation of a silver halide emulsion comprising tabular grains having a relatively high aspect ratio is performed preferably in a diluted environment so that application of the ultrafiltration is preferred to enhance the manufacturing efficiency. When conducting concentration of silver halide emulsion by ultrafiltration in the process of preparation of silver halide emulsion relating to the invention, a manufacturing installation of silver halide emulsions described in JP-A 10-339923 is preferably employed.

The concentration mechanism is connected via pipes to the reaction vessel, in which the reaction mixture solution can be circulated at an intended rate between the reaction vessel and the concentration mechanism by means of a circulation mechanism such as a pump. The facility may further be installed with an apparatus for detecting the volume of a salt containing solution extracted from the reaction mixture solution through the concentration mechanism, having a mechanism capable of controlling the volume at the intended level. There can optionally be provided other function(s).

The concentration by means of ultrafiltration is applied in the form of the following (1) or (2), or their combination:
(1) using the concentration mechanism described above, the volume of a reaction mixture solution is reduced during the process of forming silver halide grains;
(2) using the concentration mechanism described above, an aqueous solution containing soluble material is removed during the process of forming silver halide grains, in an amount equivalent to or less than that of solution added for silver halide grain formation to maintain the reaction mixture solution at a substantially constant level or to restrain an increase of the reaction solution volume.

It is preferred to reduce the reaction solution volume by the foregoing method (1) prior to introducing dislocation lines to enhance the proportion of grains containing dislocation lines.

The ultrafiltration may be conducted at any time during the process of forming silver halide grains with interrupting silver halide grain growth or concurrently with continuing the silver halide grain growth. The ultrafiltration may be conducted plural time during the grain formation process, and is performed preferably before completion of silver halide grain formation, and more preferably during silver halide grain growth.

Employing the ultrafiltration, unwanted soluble salts can be removed in the process of forming silver halide grains. There is also feasible removal or deactivation of unreacted reactants or undoped residues of compounds added during the grain formation, including a reducing agent, oxidizing agent, halogen ion releasing compound, silver halide solvent, polyvalent metal, polyvalent metal ion, polyvalent metal complex, polyvalent metal ion complex, and the like. It is also possible to perform control of silver halide grain growth conditions, for example, control of the distance between grains and control of a pH or a pBr for silver halide grain growth, control of the reaction solution volume and concentration thereof.

Ultrafiltration employing membrane separation is described in “Kagakukogaku Binran 5th Ed.” (Handbook of Chemical Engineering, edited by Kagakukogaku Kyokai, Maruzen) page 924-954; RD vol. 102, item 10208, ibid vol. 131, item 13122; JP-B Nos. 59-43727 and 62-27008; JP-A Nos. 62-113137, 57-209823, 59-43727, 62-113137, 61-219948, 62-23035, 63-40137, 63-40039, 3-140946, 2-172816, 2-172817, and 4-22942. Apparatuses or methods described in JP-A 11-339923 and 11-231448 are also usable in this invention.

In the process of the preparation of silver halide emulsions of this invention, the low temperature nucleation is conducted preferably at a temperature of 40° C. or lower, more preferably 30° C. or lower, and still more preferably 25° C. or lower; and the high temperature ripening conducted preferably at a temperature of 55° C. or higher, more preferably from 58° C. to 90° C., and still more preferably from 62° C. to 77° C.

In the preparation of a silver halide emulsion, at least once desalting step may be provided in the course of grain formation. The desalting is the procedure of washing the silver halide emulsion to remove soluble salts. The desalting, which is referred to Research Disclosure (hereinafter, also denoted simply as RD) 17643, sect. II, can be conducted preferably by the flocculation method using inorganic salts, anionic surfactant or anionic polymers, e.g., poly(styrenesulfonic acid). The salting step is conducted at the time of less than 10% of the volume of the grown-up grain, and more preferably less than 5%. In the preparation of the silver halide emulsion of this invention, desalting is preferably conducted after completion of the grain growth step. Thus, to remove soluble salts from the emulsion after forming precipitates or completing physical ripening, there may be employed a noodle washing method by chill-setting gelatin or a coagulation washing (flocculation) by using inorganic salts, anionic surfactants, anionic polymers (e.g., polystyrene sulfonic acid, etc.) or gelatin derivatives (e.g., acylated gelatin, carbamoylated gelatin, etc.). Ultrafiltration employing the foregoing membrane separation is also preferably employed for desalting.

In the nucleation and/or grain growth using fine silver halide grains in the silver halide emulsion relating to this invention, it is preferred to perform the nucleation and/or grain growth described above using a mixer provided outside a reaction vessel. The mixer provided outside the reaction vessel preferably is continuous nucleation equipment, in which nuclei or fine silver halide grains are continuously formed and continuously supplied to the reaction vessel. The continuous nucleation equipment is described in JP-A No. 2000-112049.

The foregoing continuous nucleation equipment preferably is small in volume, and it is preferred that plural are connected in parallel in accordance with the intended production amount to perform simultaneous nucleation.

Polyalkyleneoxide compounds described in U.S. Pat. No. 5,252,453 are preferably used in this invention.

There may be used crystal face index-controlling agents (or crystal-habit modifiers) for silver halide grains, as described in U.S. Pat. Nos. 4,680,256, 4,684,607, 4,680,254 and 4,680,255. Any ratio of [111] face or [100] face of the side-face of the tabular grain, and the [100] face preferably accounts for at least 20% of the whole side-face, and more preferably at least 30%.

When reduction sensitization is conducted in the formation of silver halide grains, there are usable a radical scavenger or other additives for control of oxidation of silver nuclei.

Manufacture of silver halide emulsions relating to this invention is described in JP-A Nos. 61-6643, 61-14630, 61-112142, 62-157024, 62-18556, 63-92942, 63-151618, 63-163451, 63-220238, 63-311244; RD38957 sect. I and III, RD40145 sect. XV.

In cases when constituting a color photographic material using silver halide emulsions according to the invention are employed silver halide emulsions according to the invention, which have been subjected to physical ripening, chemical sensitization and spectral sensitization. Additives used in such a process are described in RD38957, Sect. IV and V, RD40145, Sect. XV. Commonly known photographic additives usable in the invention are also describe din RD 38957, Sect. II to X and RD 40145, Sect. I to XIII.

Silver halide photographic materials relating to the invention may be provided with red-, green- and blue-sensitive silver halide emulsion layers, each of which may each preferably exhibit an absorption maximum farther by at least 20 nm the other dyes. The use of a cyan coupler, magenta coupler and yellow coupler is preferred as a coupler. The combination with a coupler and an emulsion layer is preferably the combination of a yellow coupler and a blue-sensitive layer, that of a magenta coupler and a green-sensitive layer, and that of a cyan coupler and a red-sensitive layer, but is not limited to these combinations and other combinations may be acceptable.

DIR compounds may be used in the invention. Examples of DIR compounds usable in the invention include those described in JP-A 4-114153, D-1 through D-34. These compounds are preferably used in the invention. Further, examples of usable DIR compounds include those described in U.S. Pat. Nos. 4,234,678, 3,227,554, 3,647,291, 3,958,993, 4,419,886, 3,933,500; JP-A 57-56837, 51-13239; U.S. Pat. Nos. 2,072,363, 2,070266; and RD 40145, Sect. XIV.

Exemplary examples of couplers usable in the invention are those described in RD 40145, Sect. II. Additives used in the invention can be incorporated using a dispersing method described in RD 40145, Sect. VIII. Commonly known supports, for example, as described in RD 38957, Sect. XV are also usable in the invention. Auxiliary layers such as a filter layer or interlayer, as described din RD 38957, Sect. XI may be provided in photographic materials relating to the invention. Photographic materials can have various layer arrangements such as convention layer order, reverse order and unit constitution, as described in RD 38957, Sect. XI.

Silver halide emulsions according to the invention can be applied to various color photographic materials, such as color negative films used for general purpose or cine films, color reversal films for reversal or television, color paper, color positive films, color reversal paper.

Photographic materials relating to the invention can be processed using commonly known developers describe in T. H. James, The Theory of The Photographic Process, Forth Edition, pages 291 to 334; J. Am. Chem. Soc. 73, 3100 (1951), in accordance with the conventional process, as described in RD 38957, Sect. XVII to XX, and RD 40145, Sect. XXIII.

### EXAMPLES

The present invention will be further described based on examples, but embodiments of the invention are by no means limited to these.

### Example 1

### Preparation of Tabular Grain Emulsion

Preparation of Emulsion Em 1-1

Tabular grain emulsion Em 1-1 was prepared in the manner described below.

Low Temperature Nucleation Step:

A 10.47 lit. an aqueous solution containing 70.7 g of gelatin A (alkali-process inert gelatin having an average molecular weight of 100,000 and a methionine content of 55 mmol/g) of a pBr of 2.0 was maintained at 35° C. and adjusted to a pH of 1.90 using an aqueous 0.5 mol/l sulfuric acid solution, while stirring at a high speed using a mixing stirrer, as described in JP-A No. 62-160128. Thereafter, the following solutions, S-1 and X-1 were added by double jet addition in one minute to perform nucleation.
S-1 Solution: 88.75 ml of 1.25 mol/l aqueous silver nitrate solution
X-1 Solution: 88.75 ml of 1.25 mol/l aqueous potassium bromide solution
   Temperature Rising Step:

After completion of the nucleation step, solution G-01 was further added thereto and the temperature was raised to 65° C. in 55 min. Immediately after rising the temperature, r the pBr was continuously controlled from 2.5 to 1.9 using an aqueous 1.75 mol/l potassium bromide solution.
G-1 Solution: 1260 ml of aqueous solution containing 52.0 g of gelatin A and 3.78 ml of a 10% methanol solution of surfactant (EO-1).
Surfactant A: [CH(CH₃)CH₂O]₁₇[(CH₂CH₂O)ₙCOCH₂CH₂COONa](n=5.7/2)
   High Temperature Ripening Step:

After reached 65° C., an aqueous solution containing ammonium nitrate was added thereto, the pH was adjusted to 11.3 using aqueous potassium hydroxide solution and maintained for 6 min. 30 sec. Then, the pH was adjusted to 6.1 using an aqueous acetic acid solution.

Growth Step-1:

After completion of the ripening step, solutions S-02 and X-02 were added by double jet addition at an accelerated flow rate, while maintaining the temperature at 65° C., the pH and pBr at 6.1 and 1.8 with a 56% aqueous acetic acid solution and a 1.75 mol/l aqueous potassium bromide solution, respectively.
S-2 Solution: 1130 ml of 1.25 mol/l aqueous silver nitrate solution,
X-2 Solution: 1130 ml of 1.25 mol/l aqueous potassium bromide solution.

After completion of addition of the solutions, the resulting emulsion was desalted by using an aqueous Demol (produced by Kao-Atlas) and an aqueous magnesium sulfate solution, and the gelatin A was further added thereto and dispersed to obtain a seed emulsion.

Growth Step-2:

Subsequently, the seed emulsion prepared in the growth step-1 was further grown in accordance with the following procedure, in which the mixing stirrer, as described in JP-A No. 62-160128 was used, and to remove soluble components from the reaction mixture by means of ultrafiltration was employed an apparatus described in JP-A No. 10-339923. Thus, to reaction mother liquor containing 0.359 mol. equivalent seed emulsion and 0.12 ml of a 10% methanol solution of the foregoing surfactant A, water and 345.8 g of gelatin A were added to make 24.9 lit., then, the following solutions S-3 and X-3 were added by double jet addition at an accelerated flow rate with maintaining the pAg at 9.4 with a 1.75 mol/l aqueous potassium bromide solution and a temperature of 60° C., while soluble components in the reaction mixture were removed by ultrafiltration to maintain the reaction mixture at a constant volume.
S-3 Solution: 3730 ml of 1.75 mol/l aqueous silver nitrate solution,
X-3 Solution: 3730 ml of 1.75 mol/l potassium bromide

Further, the following solutions S-4 and X-4 were added by double jet addition at an accelerated flow rate.
S-4 Solution: 303 ml of 1.75 mol/l aqueous silver nitrate solution,
X-4 Solution: 303 ml of 1.698 mol/l potassium bromide and 0.053 mol/l potassium iodide aqueous solution.

Subsequently, 6.0 lit. of soluble components in the reaction mixture were removed by ultrafiltration over 25 min.

Then, the following solution N-3 was added over 8 min. and after maintained for 2 min., the pAg was adjusted to 9.4 with a 1.75 mol/l aqueous potassium bromide solution.
N-3 Solution: 1733 ml of aqueous solution containing 0.350 mol. equivalent silver iodide emulsion exhibiting a coefficient of variation of grain size of 20% and 51.98 g of gelatin

Subsequently, the following solutions S-5 and X-5 were added at an accelerated flow rate.
S-5 Solution: 1011 ml of 1.75 mol/l aqueous silver nitrate solution,
X-5 Solution: 1011 ml of 1.663 mol/l potassium bromide and 0.088 mol/l potassium iodide aqueous solution.

Subsequently, the following solutions S-6 and X-6 were added at an accelerated flow rate.
S-6 Solution: 605 ml of 1.75 mol/l aqueous silver nitrate solution,
X-6 Solution: 605 ml of 1.75 mol/l potassium bromide

After completion of addition, aqueous solution containing 360 g of chemically modified gelatin (in which the amino group was phenylcarbamoyled at a modification percentage of 95%) was added to perform desalting and washing, and then the gelatin A was further added and dispersed, followed by adjusting the pH and pAg to 5.8 and 8.9, respectively, at 40° C. Tabular silver halide grain emulsion Em 1-1 (hereinafter, also denoted simply as emulsion Em 1-1) was thus obtained.

Preparation of Emulsion Em 1-2

Tabular grain emulsion Em 1-2 was prepared similarly to the foregoing emulsion Em 1-1, except that the gelatin A used in the low temperature nucleation step, the temperature rising step and the growth step-1 was replaced by gelatin B (acid process gelatin having an average molecular weight of 100,000 and a methionine content of 5 μmol/g), and the pH was maintained at 8.8, while adding solutions S-3 and X-3 in the growth step-2.

Preparation of Emulsion Em 1-3

Tabular grain emulsion Em 1-3 was prepared similarly to the foregoing emulsion Em 1-1, except that the temperature within the reaction vessel was maintained at 25° C. in the nucleation and temperature rising steps and the pAg was maintained at 8.36, while adding solutions S-3 and X-3 in the growth step-2.

Preparation of Emulsion Em 1-4

Tabular grain emulsion Em 1-4 was prepared similarly to the foregoing emulsion Em 1-3, except that the pAg was maintained at 8.36, while adding solutions S-3 and X-3 in the growth step-2.

Preparation of Emulsion Em 1-5

Tabular grain emulsion Em 1-5 was prepared similarly to the foregoing emulsion Em 1-2, except that the temperature within the reaction vessel was maintained at 25° C. in the nucleation step.

Preparation of Emulsion Em 1-6

Tabular grain emulsion Em 1-6 was prepared similarly to the foregoing emulsion Em 1-3, except that the temperature within the reaction vessel was maintained at 20° C. in the nucleation step.

Preparation of Emulsion Em 1-7

Tabular grain emulsion Em 1-7 was prepared similarly to the foregoing emulsion Em 1-4, except that the temperature within the reaction vessel was maintained at 20° C. in the nucleation step.

Preparation of Emulsion Em 1-8

Tabular grain emulsion Em 1-8 was prepared similarly to the foregoing emulsion Em 1-5, except that the temperature within the reaction vessel was maintained at 20° C. in the nucleation step.

Preparation of Emulsion Em 1-9

Tabular grain emulsion Em 1-9 was prepared similarly to the foregoing emulsion Em 1-8, except that the temperature was raised to 75° C. in the temperature rising step and the amount of aqueous ammonium nitrate solution added in the high temperature ripening step was reduced to a factor of 0.6.

Preparation of Emulsion Em 1-10

Tabular grain emulsion Em 1-10 was prepared similarly to the foregoing emulsion Em 1-9, except that the gelatin B used in the nucleation step was replaced by gelatin C (oxidized gelatin having an average molecular weight of 20,000 and a methionine content of 5 μmol/g).

Preparation of Emulsion Em 1-11

Tabular grain emulsion Em 1-11 was prepared similarly to the foregoing emulsion Em 1-8, except that the addition amount and addition rate solution X-6 used in the growth step-2 was reduced and the pAg was adjusted to 8.8 after completion of addition.

Preparation of Emulsion Em 1-12

Tabular grain emulsion Em 1-12 was prepared similarly to the foregoing emulsion Em 1-8, except that the addition amount and addition rate solution X-6 used in the growth step-2 was reduced and the pAg was adjusted to 8.5 after completion of addition.

Characteristics of the thus prepared tabular grain emulsions Em 1-1 to 1-12 are shown in Table 1, in which the average aspect ratio and the coefficient of variation thereof (denoted simply as C.V.), the [100] face ratio of the side-face and the coefficient of variation (C.V.) thereof, K, L and the percentage of grains falling within the range of from K to (K+2) and from L to (L+10), the average equivalent circle diameter and coefficient of variation thereof Y (denoted simply as C.V. Y), and the average surface iodide content of the major faces were each determined in the manner described earlier. The coefficient of variation of equivalent circle diameter (X) was determined according to the equation (1) described earlier.

TABLE 1

| | | | | | | | | | | | Average | |
|---|---|---|---|---|---|---|---|---|---|---|---|---|
| | Aspect Ratio | | | [100] Side | | | | Equivalent Circle | | | Surface Iodide | |
| | (AR) | | | Face | | | | Diameter (ECD) | | | Content of | |
| Emulsion | Av. | | C.V. | Ratio | | C.V. | *1 | Av. ECD | C.V. | C.V. | Major Face | |
| No. | AR | K | (%) | (%) | L | (%) | (%) | μm | Y (%) | X (%) | (mol %) | Remark |
| Em1-1 | 18 | 17 | 45 | 18 | 13 | 55 | 20 | 2.41 | 26 | 16.8 | 10 | Comp. |
| Em1-2 | 18 | 17 | 35 | 18 | 13 | 55 | 30 | 2.41 | 19 | 16.8 | 10 | Comp. |
| Em1-3 | 6 | 5 | 35 | 25 | 20 | 45 | 40 | 1.67 | 11 | 9.6 | 10 | Inv. |
| Em1-4 | 10 | 9 | 35 | 22 | 17 | 45 | 40 | 1.98 | 13 | 12.0 | 10 | Inv. |
| Em1-5 | 18 | 17 | 35 | 18 | 13 | 45 | 40 | 2.41 | 19 | 16.8 | 10 | Inv. |
| Em1-6 | 6 | 5 | 25 | 25 | 10 | 35 | 50 | 1.67 | 11 | 9.6 | 10 | Inv. |
| Em1-7 | 10 | 9 | 25 | 22 | 17 | 35 | 50 | 1.98 | 13 | 12.0 | 10 | Inv. |
| Em1-8 | 18 | 17 | 25 | 18 | 13 | 35 | 50 | 2.41 | 19 | 16.8 | 10 | Inv. |
| Em1-9 | 18 | 17 | 15 | 18 | 13 | 35 | 55 | 2.41 | 17 | 16.8 | 10 | Inv. |
| Em1-10 | 18 | 17 | 15 | 18 | 13 | 25 | 65 | 2.41 | 17 | 16.8 | 10 | Inv. |
| Em1-11 | 18 | 17 | 25 | 32 | 27 | 35 | 50 | 2.41 | 17 | 16.8 | 10 | Inv. |
| Em1-12 | 18 | 17 | 25 | 45 | 40 | 35 | 50 | 2.41 | 17 | 16.8 | 10 | Inv. |

*1: percentage by number of grains having [111] major faces, an aspect ratio of from K to (K + 2) and [100] side faces with a proportion of from L % to (L + 10) %

### Chemical Sensitization of Emulsion

The emulsions Em 1-1 to Em 1-12 were each heated to 57° C. and further thereto were added a sensitizing dyes as used in the 9th layer of a color photographic material described later, trifurylphosphineselenide, chloroauric acid, potassium thiocyanate and sodium thiosulfate pentahydrate, and then chemically ripened at a silver potential of 50 mV and a pH of 6.5 so as to achieve optimum sensitivity. After completion of chemical ripening, 6-methyl-4-hydroxy-1,3,3a,7-tetrazaindene, disulfide compound (1-6) described in JP-A 2002-90957, and fine silver iodide grains were added to the emulsion and the emulsion was cooled and solidified to complete spectral sensitization and chemical sensitization.

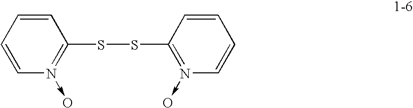

### Preparation of Photographic Material

On a subbed 120 μm thick polyethyleneterephthalate film support, the following layers having composition as shown below were formed to prepare a multi-layered color photographic material samples. The addition amount of each compound was represented in term of g/m², unless otherwise noted. The amount of silver halide or colloidal silver was converted to the silver amount and the amount of a sensitizing dye (designated as “SD”) was represented in mol/Ag mol.

The foregoing chemically and spectrally sensitized tabular silver halide emulsions Em 1-1 through Em 1-12 were respectively used as silver iodobromide emulsion G used in the 9th layer described below to prepare photographic material samples No. 1-1 through 1-12.

| 1st Layer: Anti-Halation Layer | |
|---|---|
| Black colloidal silver | 0.16 |
| UV-1 | 0.30 |
| F-1 | 0.012 |
| CM-1 | 0.12 |
| OIL-1 | 0.25 |
| Gelatin | 1.40 |
| 2nd Layer: Interlayer | |
| AS-1 | 0.12 |
| OIL-1 | 0.15 |
| Gelatin | 0.67 |
| 3rd Layer: Low-speed Red-Sensitive Layer | |
| Silver iodobromide emulsion A | 0.24 |
| Silver iodobromide emulsion B | 0.24 |
| Silver iodobromide emulsion C | 0.32 |
| SD-1 | 4.8 × 10⁻⁴ |
| SD-2 | 7.1 × 10⁻⁴ |
| SD-3 | 7.6 × 10⁻⁵ |
| SD-4 | 2.0 × 10⁻⁴ |
| C-1 | 0.18 |
| C-2 | 0.62 |
| CC-1 | 0.007 |
| OIL-2 | 0.48 |
| Gelatin | 1.88 |
| 4th Layer: Medium-speed Red-sensitive Layer | |
| Silver iodobromide emulsion D | 0.75 |
| Silver iodobromide emulsion A | 0.40 |
| SD-1 | 4.5 × 10⁻⁴ |
| SD-2 | 5.9 × 10⁻⁵ |
| SD-4 | 2.8 × 10⁻⁴ |
| C-1 | 0.40 |
| CC-1 | 0.07 |
| DI-1 | 0.053 |
| OIL-2 | 0.26 |
| Gelatin | 1.36 |
| 5th Layer: High-speed Red-Sensitive Layer | |
| Silver iodobromide emulsion E | 1.56 |
| Silver iodobromide emulsion D | 0.17 |
| SD-1 | 2.1 × 10⁻⁴ |
| SD-2 | 1.0 × 10⁻⁴ |
| SD-4 | 2.8 × 10⁻⁵ |
| SD-13 | 2.8 × 10⁻⁴ |
| SD-9 | 1.5 × 10⁻⁵ |
| C-1 | 0.12 |
| C-3 | 0.17 |
| CC-1 | 0.016 |
| DI-4 | 0.01 |
| DI-5 | 0.046 |
| OIL-2 | 0.18 |
| OIL-3 | 0.19 |
| Gelatin | 1.59 |
| 6th Layer: Interlayer | |
| Y-1 | 0.11 |
| AS-1 | 0.18 |
| OIL-1 | 0.26 |
| AF-6 | 0.001 |
| Gelatin | 1.00 |
| 7th Layer: Low-speed Green-Sensitive Layer | |
| Silver iodobromide emulsion F | 0.20 |
| Silver iodobromide emulsion C | 0.20 |
| SD-5 | 3.2 × 10⁻⁵ |
| SD-6 | 5.0 × 10⁻⁴ |
| SD-7 | 9.2 × 10⁻⁵ |
| SD-8 | 1.6 × 10⁻⁴ |
| M-1 | 0.33 |
| CM-1 | 0.052 |
| DI-2 | 0.013 |
| AS-2 | 0.001 |
| OIL-1 | 0.35 |
| Gelatin | 1.13 |
| 8th Layer: Medium-speed Green-Sensitive Layer | |
| Silver iodobromide emulsion D | 0.52 |
| Silver iodobromide emulsion F | 0.22 |
| SD-5 | 3.0 × 10⁻⁵ |
| SD-6 | 4.2 × 10⁻⁴ |
| SD-7 | 1.8 × 10⁻⁴ |
| SD-8 | 1.6 × 10⁻⁴ |
| M-1 | 0.14 |
| CM-1 | 0.043 |
| CM-2 | 0.044 |
| DI-3 | 0.0044 |
| DI-2 | 0.027 |
| AS-4 | 0.0059 |
| AS-3 | 0.015 |
| AS-5 | 0.043 |
| OIL-1 | 0.27 |
| Gelatin | 1.04 |
| 9th Layer: High-speed Green-Sensitive Layer | |
| Silver iodobromide emulsion G | 1.57 |
| SD-5 | 1.1 × 10⁻⁴ |
| SD-6 | 5.1 × 10⁻⁴ |
| SD-8 | 9.3 × 10⁻⁵ |
| SD-9 | 1.5 × 10⁻⁵ |
| M-1 | 0.052 |
| M-2 | 0.099 |
| CM-2 | 0.011 |
| DI-3 | 0.0034 |
| AS-2 | 0.0069 |
| AS-5 | 0.045 |
| AS-3 | 0.023 |
| OIL-1 | 0.28 |
| OIL-3 | 0.20 |
| Gelatin | 1.54 |
| 10th Layer: Yellow Filter Layer | |
| F-2 | 0.048 |
| F-3 | 0.04 |
| AS-1 | 0.15 |
| OIL-1 | 0.18 |
| Gelatin | 0.67 |
| 11th Layer: Low-speed Blue-sensitive Layer | |
| Silver iodobromide emulsion H | 0.19 |
| Silver iodobromide emulsion I | 0.24 |
| Silver iodobromide emulsion J | 0.11 |
| SD-12 | 3.4 × 10⁻⁴ |
| SD-11 | 1.1 × 10⁻⁴ |
| SD-10 | 2.1 × 10⁻⁴ |
| SD-9 | 3.0 × 10⁻⁵ |
| Y-1 | 1.09 |
| DI-6 | 0.021 |
| AS-2 | 0.0016 |
| OIL-1 | 0.33 |
| X-1 | 0.11 |
| Gelatin | 2.06 |
| 12th Layer: High-sped Blue-sensitive Layer | |
| Silver iodobromide emulsion K | 1.33 |
| Silver iodobromide emulsion I | 0.17 |
| Silver iodobromide emulsion L | 0.17 |
| SD-12 | 2.2 × 10⁻⁴ |
| SD-10 | 3.6 × 10⁻⁵ |
| SD-9 | 3.0 × 10⁻⁵ |
| Y-1 | 0.30 |
| DI-5 | 0.11 |
| X-3 | 0.0022 |
| OIL-1 | 0.17 |
| X-1 | 0.11 |
| Calcium chloride | 0.0026 |
| OIL-3 | 0.07 |
| Gelatin | 1.30 |
| 13th Layer: First Protective Layer | |
| Silver iodobromide emulsion M | 0.30 |
| UV-1 | 0.11 |
| UV-2 | 0.056 |
| OIL-3 | 0.03 |
| X-1 | 0.078 |
| AF-6 | 0.006 |
| Gelatin | 0.80 |
| 14th Layer: Second protective Layer | |
| PM-1 | 0.13 |
| PM-2 | 0.018 |
| WAX-1 | 0.021 |
| Gelatin | 0.55 |

Characteristics of silver iodobromide emulsions used in samples are shown below.

TABLE 2

| | | | | | | Av. |
|---|---|---|---|---|---|---|
| | | Av. Grain | Av. Grain | | Av. | Surface |
| | | Diameter | Thickness | | Iodide | Iodide |
| | | (μm)/CV | (μm)/CV | Av. Aspect | Content | Content |
| Emulsion | AgX Grain*¹ | (%)*² | (%)*³ | Ratio/CV*⁴ | (mol %) | (mol %) |
| A | core/shell, Tabular | 0.96/19.0 | 0.17/18.7 | 5.8/26.6 | 3.7 | 7.1 |
| B | core/shell, cubic | 0.47/6.0 | 0.42/4.2 | 1.1/6.0 | 4.0 | 7.4 |
| C | core/shell, cubic | 0.30/8.4 | 0.27/5.0 | 1.1/7.0 | 2.0 | 3.6 |
| D | core/shell, Tabular | 1.83/25.9 | 0.20/22.3 | 10.0/30.8 | 3.8 | 6.6 |
| E | core/shell, Tabular | 3.34/36.0 | 0.20/22.2 | 17.7/40.0 | 2.2 | 5.5 |
| F | core/shell, Tabular | 0.96/19.0 | 0.17/18.7 | 5.8/26.6 | 3.7 | 7.1 |
| H | core/shell, Tabular | 1.31/14.7 | 0.39/22.0 | 3.5/22.6 | 7.9 | 8.6 |
| I | core/shell, Tabular | 0.96/19.0 | 0.17/18.7 | 5.8/26.6 | 3.7 | 7.5 |
| J | core/shell, cubic | 0.30/8.4 | 0.27/5.0 | 1.1/7.0 | 2.0 | 2.9 |
| K | core/shell, Tabular | 1.81/14.0 | 1.10/15.0 | 1.7/19.6 | 6.7 | 4.5 |
| M | homogeneous, | 0.044/15.0 | 0.04/12.0 | 1.1/12.0 | 2.0 | 4.5 |
| | tetradecahedral | | | | | |
| | fine grain | | | | | |
| L | homogeneous, | 0.45/37.0 | 0.10/50.0 | 5.1/39.0 | 2.0 | 4.8 |
| | Tabular | | | | | |

*¹characteristics of silver halide grains
*²average equivalent circle grain diameter (μm)/coefficient of variation of grain diameter (%)
*³average grain thickness (μm)/coefficient of variation of grain thickness (%)
*⁴average aspect ratio/coefficient of variation of aspect ratio

Each of emulsions described in Table 1, except for emulsion M was added with sensitizing dyes described above and chemically sensitized so as to achieve an optimum relationship between sensitivity and fog.

In each sample were added OIL-3, coating aids SU-1, SU-2 and SU-3; a dispersing aid SU-4; viscosity-adjusting agent V-1; stabilizer ST-1; two kinds polyvinyl pyrrolidone of weight-averaged molecular weights of 10,000 and 100,000 (AF-AF-1, AF-2); calcium chloride; inhibitors AF-3, AF-4, AF-5, and AF-7; hardener H-1; and antiseptic Ase-1.

Chemical structures of the compounds used in the foregoing sample are shown below.

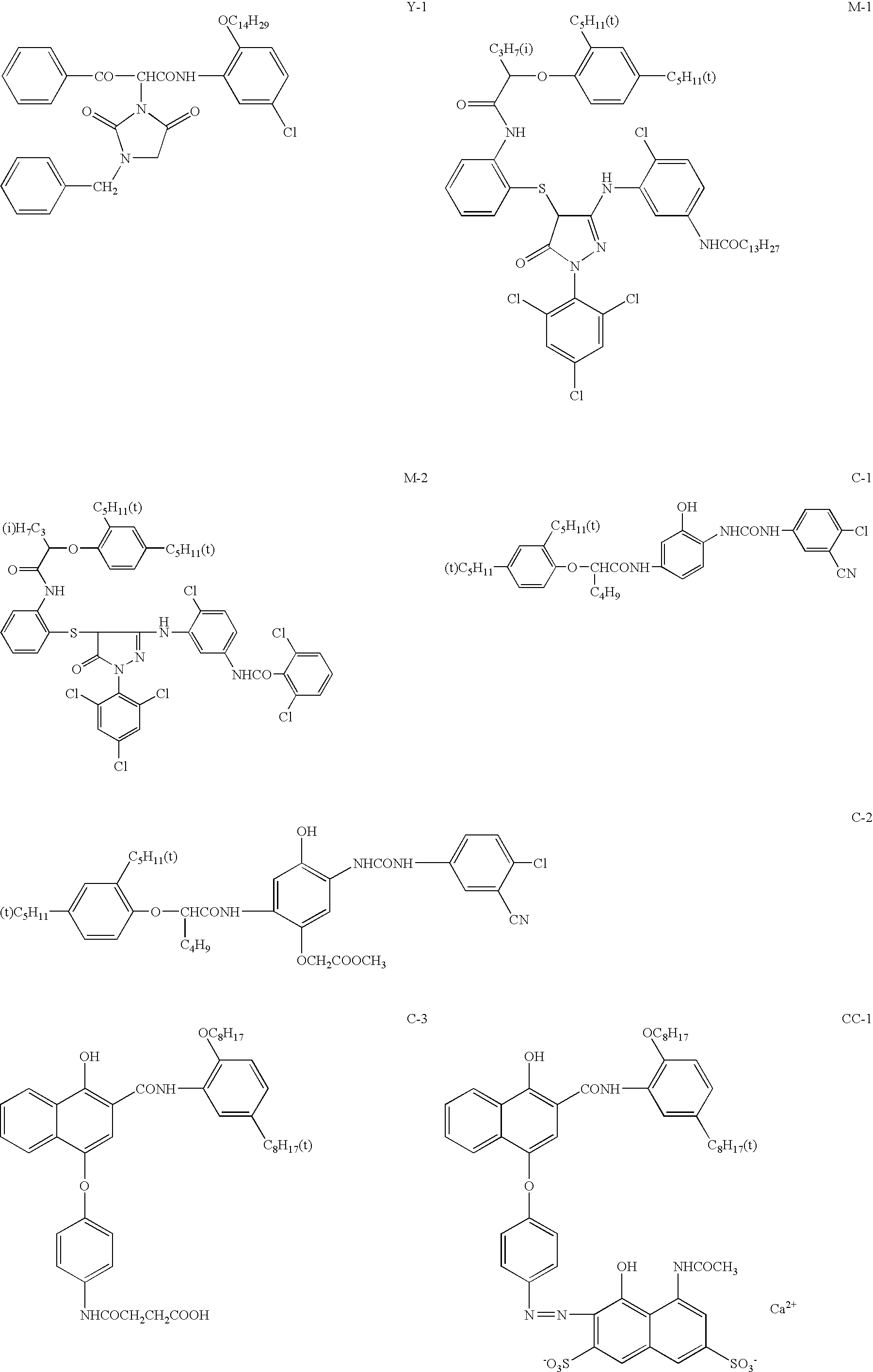

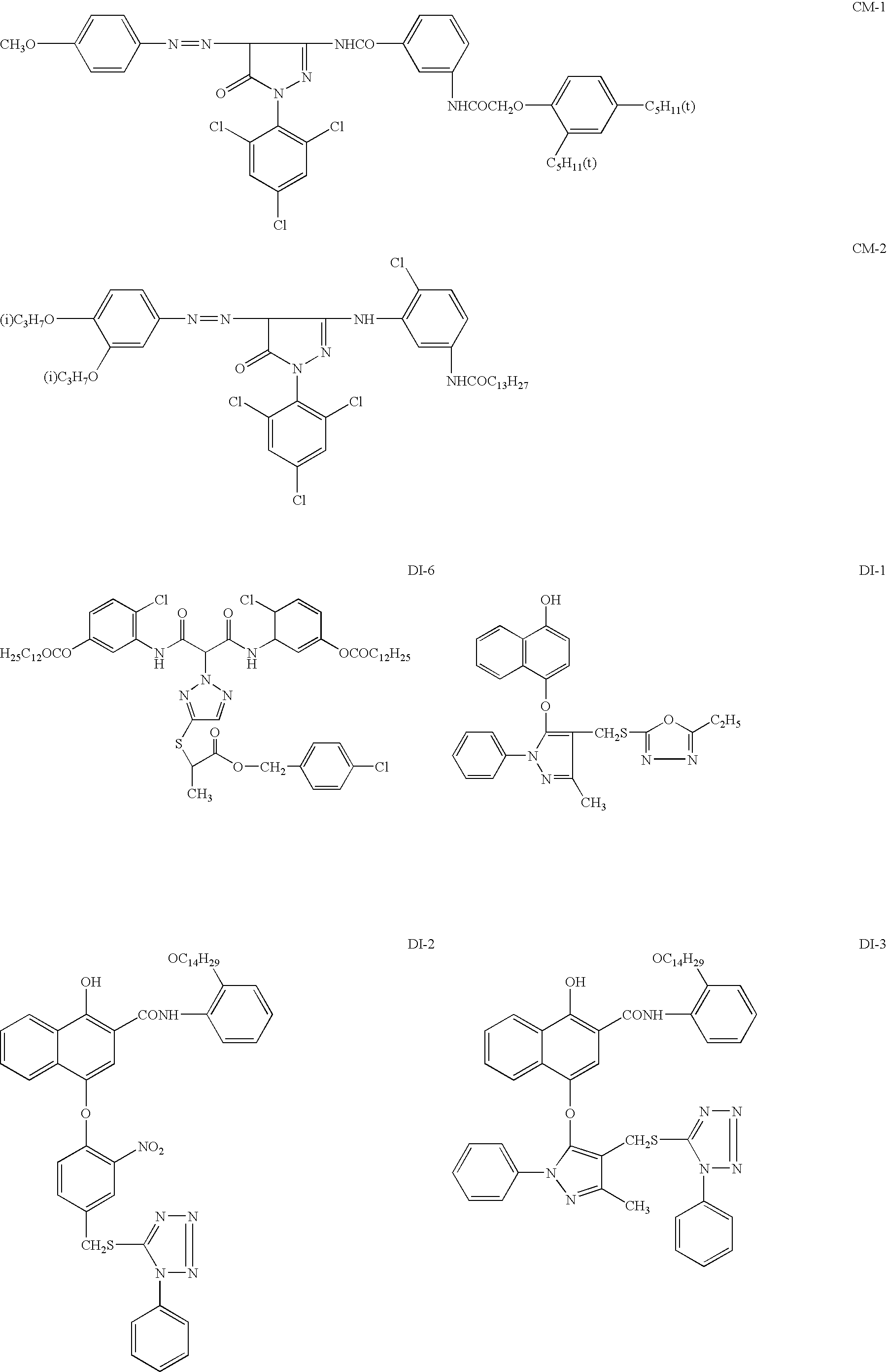

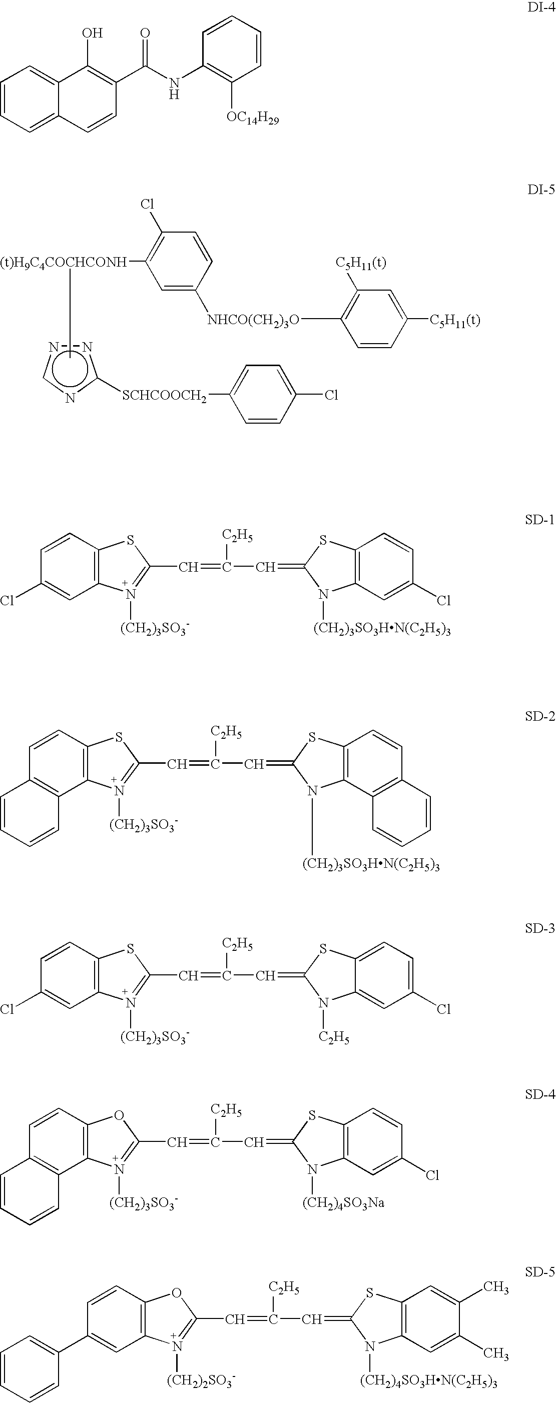

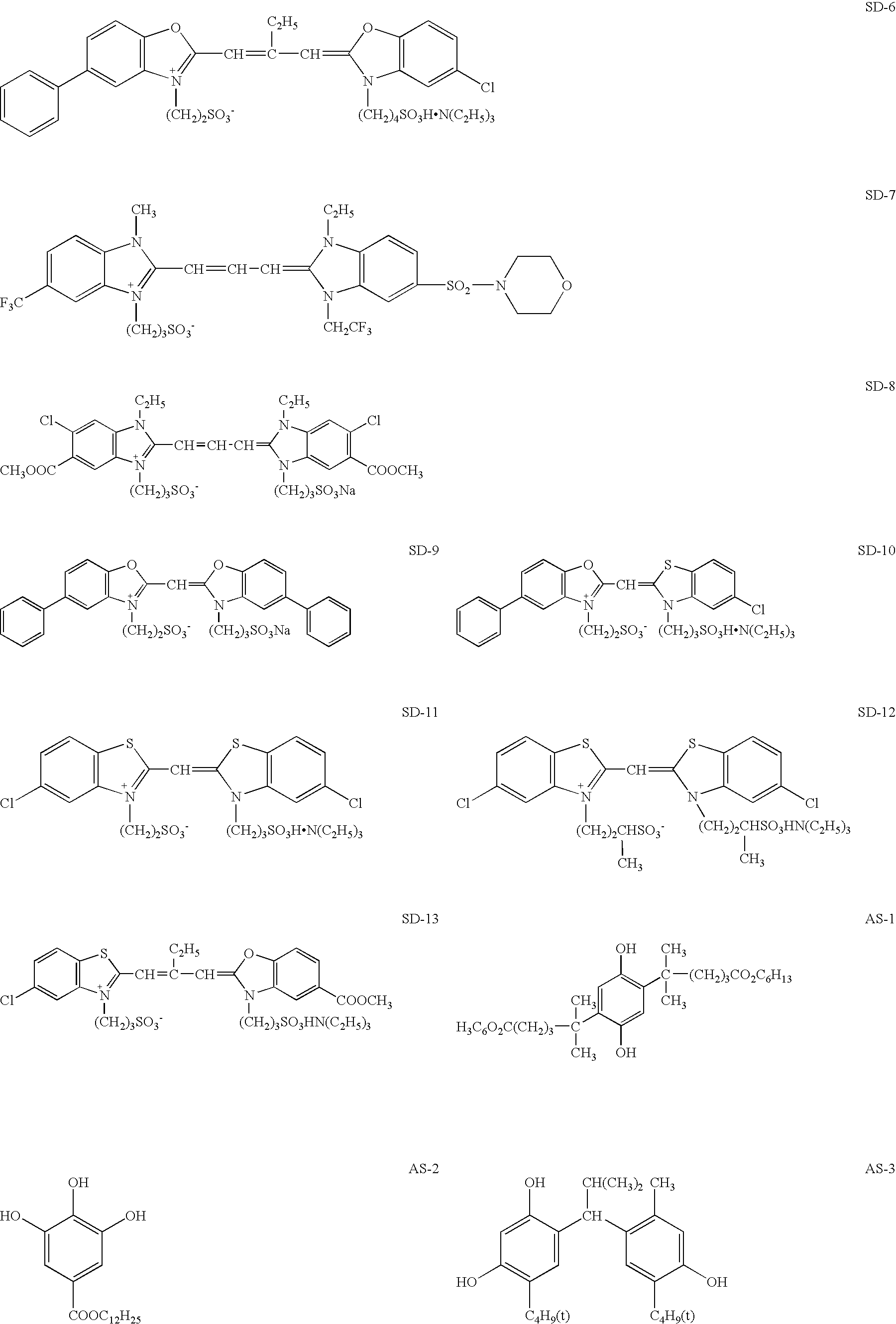

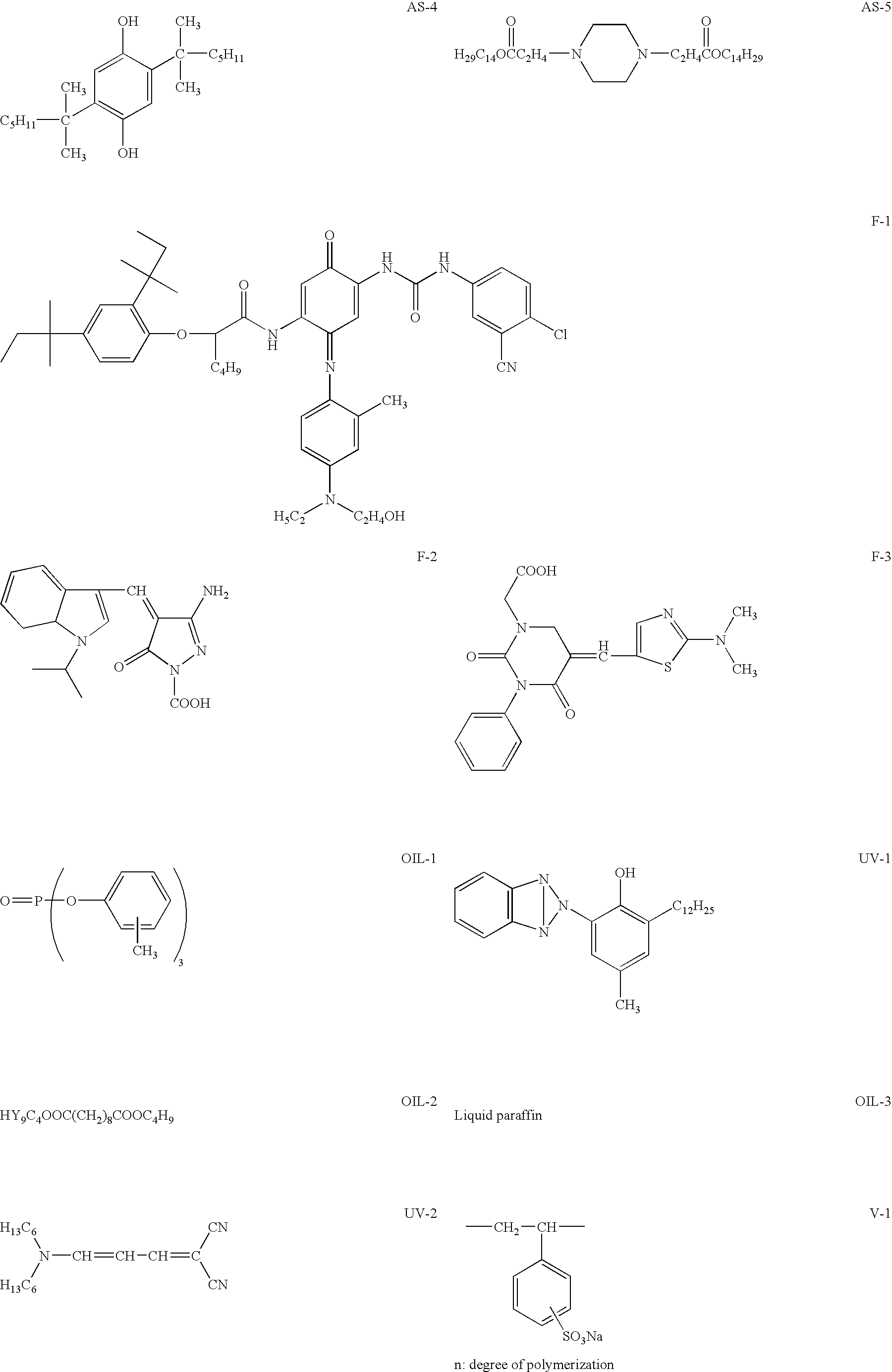

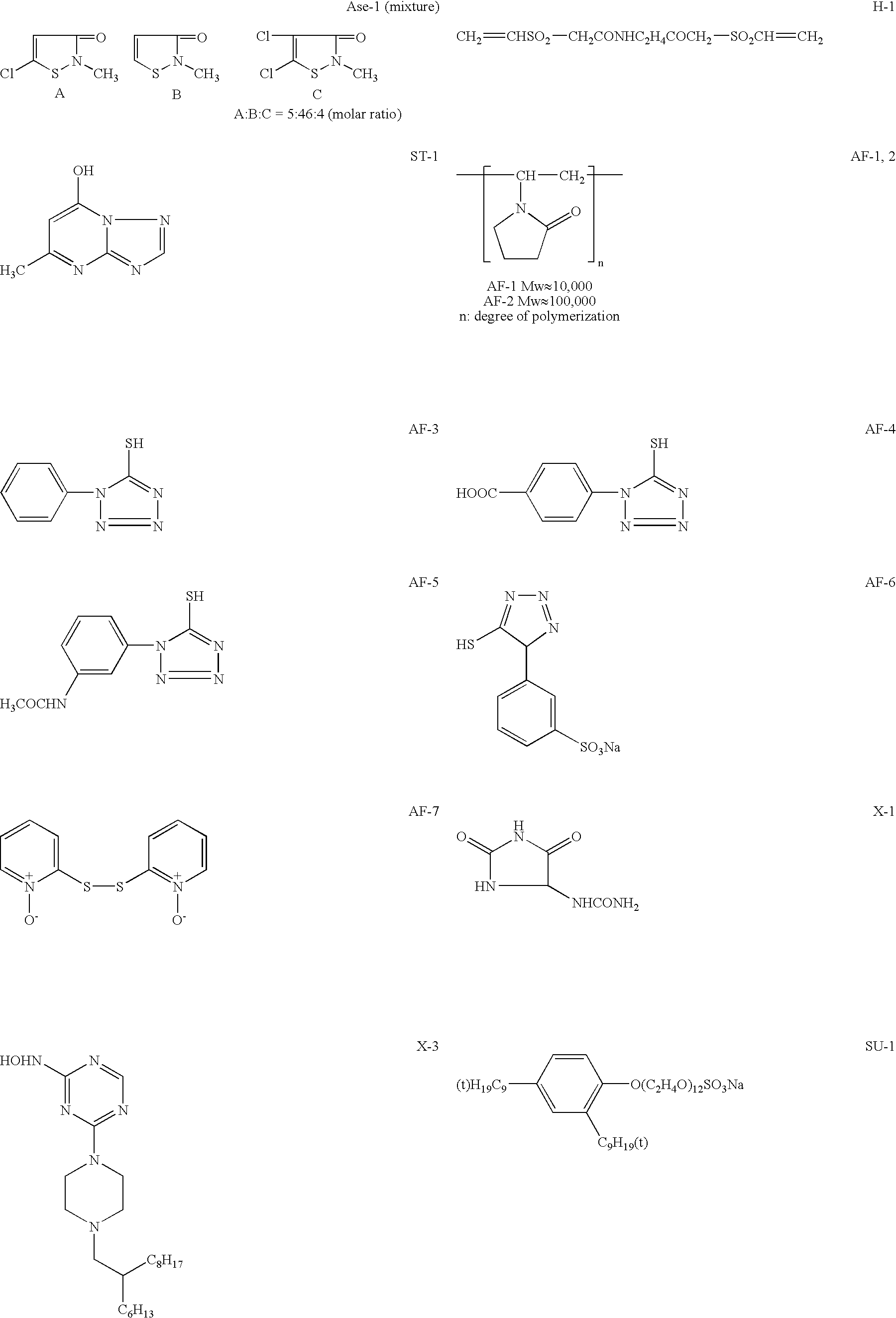

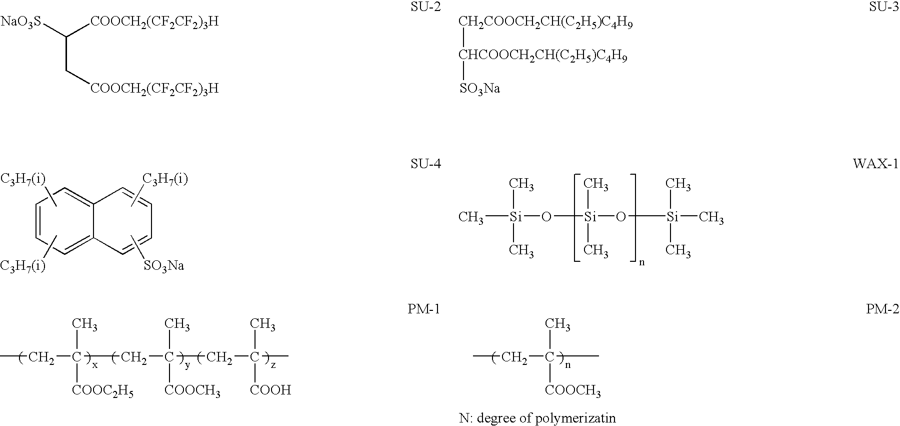

### Exposure and Processing

Exposure and processing were carried out for each of the samples as follows. Thus, the samples were each exposed to light through an optical stepped wedge for a period of 1/200 sec., using a light source exhibiting a color temperature of 5400° K and then processed in accordance with the process described in JP-A 10-123652, paragraph Nos. [0220] through [0227].

### Evaluation

Sensitivity

Subsequently, processed samples were measured with respect to magenta density, using a densitometer produced by X-rite Co. A characteristic curve of density (D) and exposure (Log E) was prepared to evaluate sensitivity. Sensitivity (hereinafter, also denoted simply as “S”) was represented by a relative value of the reciprocal of exposure necessary to give a magenta density of minimum density plus 0.20, based on the sensitivity of sample 101 being 100.

Gradation

Gradation, which was a gradient for the difference in density, was defined to be 0.20/(S₁−S₂), where, on the characteristic curve, S₁ was the reciprocal of exposure giving a magenta density of minimum density plus 0.10 and S₂ was the reciprocal of exposure giving a magenta density of minimum density plus 0.30. Gradation (hereinafter, also denoted simply as “γ”) was represented by a relative value, based on the gradation of sample 101 being 100.

Graininess

Graininess was evaluated in terms of a RMS value. The RMS value on the portion giving a magenta density of minimum density plus 0.20 was measured using green light and represented by a relative value, based on the graininess of sample 101 being 100. Thus, the measuring objective portion of each sample was scanned by a microdensitometer installed with Wratten filter of Eastman Kodak Corp. (slit width: 10 μm, slit length: 180 μm) and the RMS value was determined as a standard deviation of density with respect to the densitometric sampling number of at least 1000. The less value indicates superior graininess.

The thus obtained evaluation results are shown in Table 3.

TABLE 3

| | | | | | |
|---|---|---|---|---|---|
| Sample | Emulsion | | | | |
| No. | (9th Layer) | S | γ | Graininess | Remark |

| | | | | | |
|---|---|---|---|---|---|
| 101 | Em1-1 | 100 | 100 | 100 | Comp. |
| 102 | Em1-2 | 100 | 105 | 95 | Comp. |
| 103 | Em1-3 | 100 | 120 | 70 | Inv. |
| 104 | Em1-4 | 105 | 115 | 80 | Inv. |
| 105 | Em1-5 | 110 | 110 | 95 | Inv. |
| 106 | Em1-6 | 120 | 160 | 50 | Inv. |
| 107 | Em1-7 | 135 | 150 | 55 | Inv. |
| 108 | Em1-8 | 150 | 140 | 60 | Inv. |
| 109 | Em1-9 | 150 | 160 | 55 | Inv. |
| 110 | Em1-10 | 150 | 170 | 50 | Inv. |
| 111 | Em1-11 | 160 | 140 | 60 | Inv. |
| 112 | Em1-12 | 170 | 140 | 60 | Inv. |

As apparent from Table 3, it was proved that samples using silver halide emulsion according to this invention resulted in enhanced sensitivity and gradation, and superior graininess, compared to comparative samples.

### Example 2

Tabular grain emulsion Em 2-1 was prepared similarly to the foregoing tabular grain emulsion Em 1-5 in Example 1, except that the pAg was maintained at 9.30, while solutions S-3 and X-3 were added in the growth step-2.

Tabular grain emulsion Em 2-2 was prepared similarly to the foregoing tabular grain emulsion Em 1-5 in Example 1, except that the pAg was maintained at 9.54, while solutions S-3 and X-3 were added in the growth step-2.

Tabular grain emulsion Em 2-3 was prepared similarly to the foregoing tabular grain emulsion Em 1-8 in Example 1, except that the pAg was maintained at 9.30, while solutions S-3 and X-3 were added in the growth step-2.

Tabular grain emulsion Em 2-4 was prepared similarly to the foregoing tabular grain emulsion Em 1-8 in Example 1, except that the pAg was maintained at 9.54, while solutions S-3 and X-3 were added in the growth step-2.

Tabular grain emulsion Em 2-5 was prepared similarly to the foregoing tabular grain emulsion Em 1-8 in Example 1, except that the temperature was raised to 65° C. over 20 min. in the temperature rising step.

Tabular grain emulsion Em 2-6 was prepared similarly to the foregoing tabular grain emulsion Em 2-5, except that gelatin B used in the nucleation step was replaced by gelatin C (oxidized gelatin, average molecular weight: 20,000, methionine content: 5 mmol/g), the temperature was raised to 75° C. in the temperature rising step, and the amount of aqueous ammonium nitrate solution added in the high temperature ripening step was reduced to a factor of 0.4.

Tabular grain emulsion Em 2-7 was prepared similarly to the foregoing tabular grain emulsion Em 2-6, except that a continuous nucleation apparatus described in FIG. 1 of JP-A No. 2000-112049 was used in the nucleation step, and solutions S-1 and X-1 were added to an aqueous gelatin solution.

Characteristics of the thus prepared tabular grain emulsions Em 2-1 to Em 2-7 are shown in Table 4.

The tabular grain emulsions Em 2-1 to Em 2-7 were chemically sensitized similarly to Example 1 and photographic material samples 201 to 207 were prepared similarly to Example 1, provided that each of the foregoing emulsions was used as silver iodobromide emulsion G used in the 9th layer.

The prepared samples 201 to 207 and samples 101 and 103 to 108 of Example 1 were exposed and processed similarly to Example 1, and evaluated with respect to sensitivity, gradation and graininess similarly to Example 1. Results are shown in Table 4.

TABLE 4

| | | | | | | | | | Average | | | |
|---|---|---|---|---|---|---|---|---|---|---|---|---|
| | | | | | | | | | Surface | | | |
| | | Aspect | | | | | | | Iodide | | | |
| | | Ratio | | [100] Side | | Equivalent Circle | | | Content | | | |
| | | (AR) | | Face | | Diameter (ECD) | | | of Major | | | |
| Sample | Emulsion | Av. | C.V. | Ratio | C.V. | Av. ECD | C.V.- | C.V.- | Face | | | |
| No. | No. | AR | (%) | (%) | (%) | (μm) | Y (%) | X (%) | (mol %) | S | γ | Graininess |
| 101 | Em1-1 | 18 | 45 | 18 | 55 | 2.41 | 26 | 16.8 | 10 | 100 | 100 | 100 |
| 103 | Em1-3 | 6 | 35 | 25 | 45 | 1.67 | 11 | 9.6 | 10 | 100 | 120 | 70 |
| 104 | Em1-4 | 10 | 35 | 22 | 45 | 1.98 | 13 | 12.0 | 10 | 105 | 115 | 80 |
| 105 | Em1-5 | 18 | 35 | 18 | 45 | 2.41 | 19 | 16.8 | 10 | 110 | 110 | 95 |
| 201 | Em2-1 | 30 | 35 | 25 | 45 | 2.86 | 25 | 24.0 | 10 | 120 | 105 | 97 |
| 202 | Em2-2 | 39 | 35 | 25 | 45 | 3.12 | 31 | 29.4 | 10 | 120 | 100 | 100 |
| 106 | Em1-6 | 6 | 25 | 25 | 35 | 1.67 | 11 | 9.6 | 10 | 120 | 160 | 50 |
| 107 | Em1-7 | 10 | 25 | 22 | 35 | 1.98 | 13 | 12.0 | 10 | 135 | 150 | 55 |
| 108 | Em1-8 | 18 | 25 | 18 | 35 | 2.41 | 19 | 16.8 | 10 | 150 | 140 | 60 |
| 203 | Em2-3 | 30 | 25 | 25 | 35 | 2.86 | 25 | 24.0 | 10 | 150 | 125 | 80 |
| 204 | Em2-4 | 39 | 25 | 25 | 25 | 3.12 | 31 | 29.4 | 10 | 130 | 110 | 95 |
| 205 | Em2-5 | 18 | 25 | 18 | 35 | 2.41 | 15 | 16.8 | 10 | 160 | 160 | 55 |
| 206 | Em2-6 | 18 | 25 | 18 | 35 | 2.41 | 11 | 16.8 | 10 | 160 | 175 | 50 |
| 207 | Em2-7 | 18 | 13 | 18 | 18 | 2.41 | 9 | 16.8 | 10 | 160 | 190 | 45 |

As can be seen from Table 4, it was proved that samples using a tabular grain emulsion having a small coefficient of variation of [100] face ratio, a tabular emulsion having a ECD of not more than 3.0 and a tabular rain emulsion having a (C.V.-Y) value less than a (C.V.-X) value resulted in further enhanced sensitivity, gradation and improved graininess. The (C.V.-X) value is a coefficient of variation in equivalent circle diameter defined in equation (1), and (C.V.-Y) value is a coefficient of variation in equivalent circle diameter defined in equation (2), as described earlier.

### Example 3

Tabular grain emulsion 3-1 was prepared similarly to the tabular grain emulsion 1-5 in Example 1, except that after solution N-3 was added in the growth step-2, the pAg was not adjusted and after completion of the addition of solutions S-5 and X-5, the pAg was adjusted to 9.4 using an aqueous 1.75 mol/l potassium bromide solution.

Tabular grain emulsion 3-2 was prepared similarly to the foregoing tabular grain emulsion 3-1, except that the pAg was adjusted to 9.7.

Tabular grain emulsion 3-3 was prepared similarly to the foregoing tabular grain emulsion 3-2, except that in the growth step-2, solution X-5 was replaced by the following solution X-53.
X-53 Solution: 1011 ml of 1.680 mol/l potassium bromide and 0.070 mol/l potassium iodide aqueous solution.

Tabular grain emulsion 3-4 was prepared similarly to the tabular grain emulsion 1-8 in Example 1, except that after solution N-3 was added in the growth step-2, the pAg was not adjusted and after completion of the addition of solutions S-5 and X-5, the pAg was adjusted to 9.4 using an aqueous 1.75 mol/l potassium bromide solution.

Tabular grain emulsion 3-5 was prepared similarly to the foregoing tabular grain emulsion 3-4, except that the pAg was adjusted to 9.7.

Tabular grain emulsion 3-6 was prepared similarly to the foregoing tabular grain emulsion 3-2, except that in the growth step-2, solution X-5 was replaced by the foregoing solution X-53.

Characteristics of the thus prepared tabular grain emulsions Em 3-1 to Em 3-6 are shown in Table 5.

The thus prepared tabular grain emulsions Em 3-1 to Em 3-6 were chemically sensitized similarly to Example 1 and photographic material samples 301 to 306 were prepared similarly to Example 1, provided that each of the foregoing emulsions was used as silver iodobromide emulsion G used in the 9th layer.

The thus prepared samples 301 to 306 and samples 101, 105 and 108 of Example 1 were exposed and processed similarly to Example 1, and evaluated with respect to sensitivity, gradation and graininess similarly to Example 1. Results are shown in Table 6.

TABLE 5

| | | | | | | | | | Average | | | |
|---|---|---|---|---|---|---|---|---|---|---|---|---|
| | | | | | | | | | Surface | | | |
| | | Aspect | | [100] Face | | | | | Iodide | | | |
| | | Ratio | | of Side | | Equivalent Circle | | | Content | | | |
| | | (AR) | | Face | | Diameter (ECD) | | | of Major | | | |
| Sample | Emulsion | Av. | C.V. | Ratio | C.V. | Av. ECD | C.V. | C.V. X | Face | | | |
| No. | No. | AR | (%) | (%) | (%) | (μm) | Y (%) | (%) | (mol %) | S | γ | Graininess |
| 101 | Em1-1 | 18 | 45 | 18 | 55 | 2.41 | 26 | 16.8 | 10 | 100 | 100 | 100 |
| 301 | Em3-1 | 18 | 35 | 18 | 45 | 2.41 | 19 | 16.8 | 13 | 120 | 120 | 85 |
| 105 | Em1-5 | 18 | 35 | 18 | 45 | 2.41 | 19 | 16.8 | 10 | 110 | 110 | 95 |
| 302 | Em3-2 | 18 | 35 | 18 | 45 | 2.41 | 19 | 16.8 | 8 | 107 | 107 | 95 |
| 303 | Em3-3 | 18 | 35 | 18 | 45 | 2.41 | 19 | 16.8 | 6 | 102 | 103 | 97 |
| 304 | Em3-4 | 18 | 25 | 18 | 35 | 2.41 | 19 | 16.8 | 13 | 170 | 180 | 50 |
| 108 | Em1-8 | 18 | 25 | 18 | 35 | 2.41 | 19 | 16.8 | 10 | 150 | 140 | 60 |
| 305 | Em3-5 | 18 | 25 | 18 | 35 | 2.41 | 19 | 16.8 | 8 | 140 | 130 | 70 |
| 306 | Em3-6 | 18 | 25 | 18 | 35 | 2.41 | 19 | 16.8 | 6 | 120 | 120 | 85 |

As can be seen from Table 5, it was proved that a tabular grain emulsion exhibiting relatively high surface iodide content of the major face further enhanced sensitivity and improved graininess.

1. A silver halide emulsion comprising a dispersing medium and silver halide grains, wherein at least 35% by number of the silver halide grains is accounted for by tabular grains
(a) having [111] major faces,
(b) having an aspect ratio of not less than K and not more than (K+2) wherein K is a numerical value to the first decimal place and selected to be within the range of from 8.0 to 40.0, and
(c) having side-faces with a proportion of a [100] side-face per grain of not less than L % and not more than (L+10)% wherein L is a numerical value to the first decimal place and selected to be within the range of from 5.0 to 80.0.

2. The silver halide emulsion of claim 1, wherein the tabular grains account for at least 45% by number of the silver halide grains.

3. The silver halide emulsion of claim 1, wherein the tabular grains have an average equivalent circle diameter of not more than 3 μm.

4. The silver halide emulsion of claim 3, wherein the tabular grains account for at least 45% by number of the silver halide grains.

5. The silver halide emulsion of claim 1, wherein the tabular grains have major faces having an average surface iodide content of not less than 8 mol %.

6. The silver halide emulsion of claim 5, wherein the tabular grains account for at least 45% by number of the silver halide grains.

7. The silver halide emulsion of claim 1, wherein the tabular grains account for at least 50% of the total grain projected area.

8. The silver halide emulsion of claim 1, wherein the tabular grains have an aspect ratio of not less than 8, a coefficient of variation in aspect ratio of not more than 40% and a coefficient of variation in proportion of a [100] side face per grain of not more than 50%.

9. The silver halide emulsion of claim 8, wherein the coefficient of variation in aspect ratio is not more than 30% and the coefficient of variation in proportion of a [100] side face per grain is not more than 40%.

10. The silver halide emulsion of claim 9, wherein the coefficient of variation in aspect ratio is not more than 20% and the coefficient of variation in proportion of a [100] side face per grain is not more than 30%.

11. The silver halide emulsion of claim 1, wherein the tabular grains exhibit a coefficient of variation in proportion of a [100] side face per grain is not more than 30%.

12. The silver halide emulsion of claim 1, wherein the tabular grains meet the following requirement:
Y≦X
X=0.6A+6.0
Y=(standard deviation of equivalent circle diameter)/(average equivalent circle diameter)×100
wherein A is an average aspect ratio of the tabular grains.

13. A silver halide photographic material comprising on a support a silver halide emulsion layer, wherein the silver halide emulsion layer comprises a silver halide emulsion as claimed in claim 1.
